(19) United States
(12) Patent Application Publication
(10) Pub. No.: US 2026/0186188 A1
(43) Pub. Date: Jul. 2, 2026

(54) IMAGE DISPLAY DEVICE

(71) Applicant: FUJIFILM Corporation, Tokyo (JP)

(72) Inventor: Masato MORITA, Minamiashigara-shi (JP)

(73) Assignee: FUJIFILM Corporation, Tokyo (JP)

(21) Appl. No.: 19/548,959

(22) Filed: Feb. 25, 2026

Related U.S. Application Data
(63) Continuation of application No. PCT/JP2024/032398, filed on Sep. 10, 2024.

(30) Foreign Application Priority Data
Sep. 29, 2023 (JP) 2023-169908

(51) Int. Cl. G02B 5/30

(52) U.S. Cl. CPC G02B 5/3083

(57) ABSTRACT

An object of the present invention is to provide an image display device having a small tint difference. The image display device of the present invention includes, in the following order, a polarizer, a retardation layer, and an image display element, in which an angle formed by an absorption axis of the polarizer and an in-plane slow axis of the retardation layer is 450° 5°, and the image display device satisfies predetermined relationships.

### CROSS-REFERENCE TO RELATED APPLICATIONS

This application is a Continuation of PCT International Application No. PCT/JP2024/032398 filed on Sep. 10, 2024, which claims priority under 35 U.S.C. § 119(a) to Japanese Patent Application No. 2023-169908 filed on Sep. 29, 2023. The above applications are hereby expressly incorporated by reference, in their entirety, into the present application.

### BACKGROUND OF THE INVENTION

### 1. Field of the Invention

The present invention relates to an image display device.

### 2. Description of the Related Art

In a flat panel display device such as an organic electroluminescence (EL) image display device, a retardation layer and a polarizer for optical compensation of the image display device are often provided. JP2021-076826A discloses an image display device having specific optical characteristics.

### SUMMARY OF THE INVENTION

In a case where the image display device is set to display black, a difference in tint (hereinafter, also simply referred to as “tint difference”) between a tint in a front direction of the image display device and a tint in an oblique direction of the image display device is required to be small.

The present inventors have conducted studies on the image display device disclosed in JP2021-076826A, and have found that there is room for improvement in the tint difference.

Therefore, an object of the present invention is to provide an image display device having a small tint difference.

As a result of conducting intensive studies to achieve the object, the present inventors have found that the object is achieved by the following configurations.

(1) An image display device comprising, in the following order:
a polarizer;
a retardation layer; and
an image display element,
in which an angle formed by an absorption axis of the polarizer and an in-plane slow axis of the retardation layer is 450° 5°, and
the image display device satisfies relationships of expressions (1) to (9) described later.

(2) The image display device according to (1),
in which both Rf₄₅₀(45)M and Rs₄₅₀(45)M are −25 to −5 nm,
both Rf₅₅₀(45)M and Rs₅₅₀(45)M are −15 to 5 nm, and
both Rf₆₅₀(45)M and Rs₆₅₀(45)M are −10 to 10 nm.

(3) The image display device according to (1) or (2),
in which the image display device further satisfies a relationship of an expression (3-1) described later, a relationship of an expression (6-1) described later, and a relationship of an expression (9-1) described later.

(4) The image display device according to any one of (1) to (3),
in which the retardation layer includes an A-plate and a C-plate.

According to the present invention, it is possible to provide an image display device having a small tint difference.

### BRIEF DESCRIPTION OF THE DRAWINGS

FIG. 1 is a schematic cross-sectional view of an image display device according to an embodiment of the present invention.

FIG. 2 is a schematic view showing a relationship between an absorption axis AA of a polarizer 20 and an in-plane slow axis SA of a retardation layer 30 in an image display device 10.

FIG. 3 is a schematic view for describing a tint difference.

FIG. 4 is a schematic view showing a relationship between terms in expressions (1) to (3).

FIG. 5 is a schematic view for describing a positive value or negative value of Rf₄₅₀(45)M.

FIG. 6 is a schematic view as viewed in a direction of a black arrow in FIG. 5.

FIG. 7 is a schematic view as viewed in a direction indicated by a white arrow in FIGS. 5 and 6.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

In the present specification, a numerical range represented by “to” means a range including numerical values before and after “to” as a lower limit value and an upper limit value.

In the present specification, “visible light” means light having a wavelength range of 380 to 780 nm. In addition, in a case where a measurement wavelength is not particularly specified, the measurement wavelength is 550 nm.

In the present specification, “in-plane slow axis” means a direction in which in-plane refractive index is maximum. In addition, “in-plane fast axis” means a direction in which in-plane refractive index is minimum.

In the present specification, Re(λ) and Rth(λ) represent an in-plane retardation at a wavelength λ and a thickness direction retardation at a wavelength λ, respectively. Unless otherwise specified, the wavelength λ is 550 nm.

Re(λ) and Rth(λ) are values measured at the wavelength of λ in AxoScan manufactured by Axometrics, Inc. By inputting an average refractive index ((nx+ny+nz)/3) and a film thickness (d (μm)) in AxoScan,
a slow axis direction (°);

$$Re ( λ ) = R 0 ( λ ) ; and$$

$$Rth ( λ ) = ( ( n x + ny ) / 2 - nz ) \times d$$

are calculated.
Although RO (λ) is displayed as a numerical value calculated by AxoScan, it means Re (λ).

In the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, an A-plate and a C-plate are defined as follows.

There are two types of A-plates, a positive A-plate (A-plate which is positive) and a negative A-plate (A-plate which is negative). The positive A-plate satisfies a relationship of an expression (A1) and the negative A-plate satisfies a relationship of an expression (A2) in a case where a refractive index in a film in-plane slow axis direction (in a direction in which an in-plane refractive index is maximum) is denoted by nx, a refractive index in an in-plane direction orthogonal to the in-plane slow axis is denoted by ny, and a refractive index in a thickness direction is denoted by nz. The positive A-plate has an Rth showing a positive value and the negative A-plate has an Rth showing a negative value.

$$n x > ny \approx nz \qquad Expression ( A 1 )$$

$$ny < nx \approx nz \qquad Expression ( A 2 )$$

The symbol “˜” encompasses not only a case where both sides are completely the same as each other but also a case where both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, a positive C-plate (C-plate which is positive) and a negative C-plate (C-plate which is negative). The positive C-plate satisfies a relationship of an expression (C1) and the negative C-plate satisfies a relationship of an expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

In addition, in the present specification, the “fixed” state is a state in which alignment of a liquid crystal compound is maintained. Specifically, the “immobilized” state is preferably a state in which, in a temperature range of usually 0° C. to 50° C. or in a temperature range of −30° C. to 70° C. under more severe conditions, the layer has no fluidity and a fixed alignment morphology can be stably maintained without causing a change in the alignment morphology due to an external field or an external force.

### [Image Display Device]

Hereinafter, an embodiment of the image display device according to the present invention will be described with reference to the accompanying drawings.

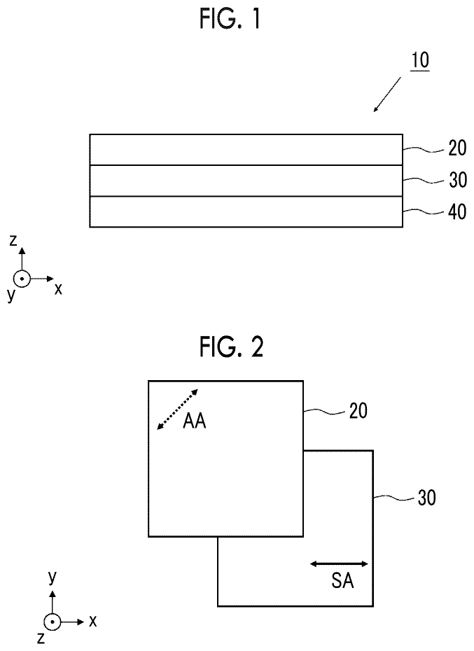

FIG. 1 shows a cross-sectional view of the embodiment of the image display device according to the present invention. The drawings in the present invention are schematic views, and the thickness relationship, the positional relationship, and the like of the respective layers do not always match the actual ones. The same applies to the following drawings.

An image display device 10 includes a polarizer 20, a retardation layer 30, and an image display element 40 in this order from a viewing side (upper side in the drawing, z-axis direction).

Examples of the feature point of the image display device according to the embodiment of the present invention include a point in which all of relationships of expressions (1) to (9) described later are satisfied, and a tint difference is reduced by satisfying all of the relationships of the expressions (1) to (9).

In addition, FIG. 2 shows a relationship between an absorption axis AA of the polarizer 20 and an in-plane slow axis SA of the retardation layer 30 in the image display device 10. In FIG. 2, the in-plane slow axis SA of the retardation layer 30 is parallel to the x-axis, and an angle formed by the absorption axis AA of the polarizer 20 and the in-plane slow axis SA of the retardation layer 30 is 45°. In FIG. 2, the absorption axis AA of the polarizer 20 is positioned at a position rotated counterclockwise by 45° with respect to the in-plane slow axis SA of the retardation layer 30; but the present invention is not limited to this aspect, and the absorption axis AA of the polarizer 20 may be positioned at a position rotated clockwise by 45° with respect to the in-plane slow axis SA of the retardation layer 30.

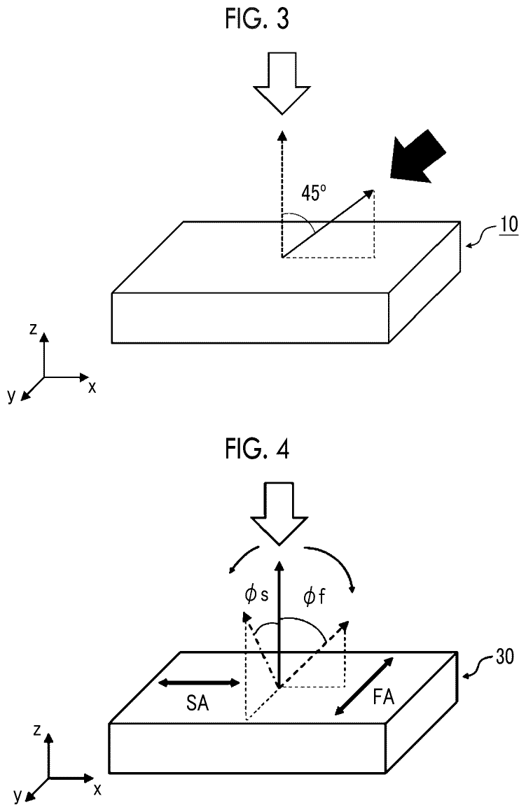

In addition, FIG. 3 is a diagram for describing the tint difference. As described above, the image display device 10 according to the embodiment of the present invention has a small tint difference. Specifically, it means that, in a case where the image display device 10 is set to display black and the display is viewed under a bright light, a difference between a tint in a case of being visually recognized from a direction indicated by a white arrow in FIG. 3, which is a direction parallel to the z-axis of the image display device 10, and a tint in a case of being visually recognized from a direction indicated by a black arrow in FIG. 3 (oblique direction of the image display device 10), which is a direction with a polar angle of 45°, is small. It is preferable that a line obtained by projecting the direction of the black arrow onto the image display device 10 is parallel to the in-plane slow axis SA of the retardation layer 30 or an in-plane fast axis FA of the retardation layer 30.

### <Polarizer>

The image display device 10 includes the polarizer 20.

The polarizer 20 is a member having a function of converting natural light (unpolarized light) into specific linearly polarized light.

Examples of the polarizer 20 include an absorptive polarizer such as an iodine-based polarizer, a dye-based polarizer using a dichroic substance, and a polyene-based polarizer. The iodine-based polarizer and the dye-based polarizer are produced, for example, by adsorbing iodine or a dichroic substance on a polyvinyl alcohol, followed by stretching.

In addition, a protective film may be disposed on one side or both sides of the polarizer 20.

A thickness of the polarizer 20 is not particularly limited, but is preferably 35 μm or less and more preferably 1 to 25 μm from the viewpoint of excellent handleability and optical characteristics.

The thickness of the polarizer 20 refers to an average thickness of the polarizer 20. The above-described average thickness is obtained by measuring thicknesses of any five or more points of the polarizer 20 and arithmetically averaging the thicknesses.

Hereinafter, in a case where a specific value of a thickness of a layer is shown, as described above, the thickness is a value obtained by measuring thicknesses of any five or more points of a certain layer and arithmetically averaging the thicknesses.

### <Retardation Layer>

The image display device 10 includes the retardation layer 30.

An angle formed by the absorption axis AA of the polarizer 20 and the in-plane slow axis SA of the retardation layer 30 is 45°, but the present invention is not limited to these aspects. In the image display device, the above-described angle is 45°+5° (in a range of 40° to 50°), preferably 45°+3° (in a range of 42° to 48°) and more preferably 45°.

The retardation layer 30 preferably includes a λ/4 plate.

It is more preferable that the retardation layer 30 includes a λ/4 plate and an optically anisotropic layer, and it is still more preferable that the retardation layer 30 includes the λ/4 plate and the optically anisotropic layer in this order from the viewing side. That is, it is still more preferable that the λ/4 plate and the optically anisotropic layer are included in this order in a direction from a tip of an arrow of the z-axis in FIG. 1 toward the origin. As the optically anisotropic layer, an optically anisotropic layer (for example, a positive C-plate) other than the λ/4 plate described later is preferable. In addition, the retardation layer 30 preferably includes an A-plate and a C-plate, and it is more preferable that the retardation layer 30 includes a positive A-plate and a positive C-plate in this order.

In addition, the λ/4 plate may be a broadband λ/4 plate which is a laminate of a λ/2 plate and a λ/4 plate.

The λ/4 plate is a plate having a function of converting linearly polarized light at a certain specific wavelength into circularly polarized light (or converting circularly polarized light into linearly polarized light), and is a plate in which Re(λ) satisfies λ/4.

The λ/4 plate is preferably an A-plate and more preferably a positive A-plate.

An angle formed by an in-plane slow axis of the λ/4 plate and the absorption axis AA of the polarizer 20 is preferably 45°±5°, more preferably 450° 3°, and still more preferably 450.

Re(450) of the λ/4 plate is preferably 90 to 135 nm, more preferably 90 to 125 nm, and still more preferably 100 to 120 nm.

Re(550) of the λ/4 plate is preferably 110 to 160 nm, more preferably 110 to 150 nm, and still more preferably 130 to 150 nm.

Re(650) of the λ/4 plate is preferably 130 to 190 nm, more preferably 130 to 180 nm, and still more preferably 140 to 160 nm.

The λ/4 plate may have forward wavelength dispersibility or reverse wavelength dispersibility, and it is preferable to have reverse wavelength dispersibility. It is preferable that the reverse wavelength dispersibility is exhibited in a visible light region.

In the present specification, the “reverse wavelength dispersibility” refers to a case where, in a case of measuring a Re value of the retardation layer in a visible light range, the Re value is the same or higher as the measurement wavelength increases.

A thickness of the λ/4 plate is preferably 1.0 to 10.0 μm and more preferably 1.0 to 5.0 m.

Examples of a manufacturing method of the λ/4 plate include a method of horizontally aligning a rod-like polymerizable liquid crystal compound. Examples thereof include a manufacturing method of a positive A-plate, described in JP2008-225281A and JP2008-026730A.

Examples of a manufacturing method of the reverse wavelength dispersible λ/4 plate include a method of horizontally aligning a liquid crystal compound having reverse wavelength dispersibility. Examples of the liquid crystal compound having reverse wavelength dispersibility include compounds represented by General Formula (I) described in JP2008-297210A (in particular, compounds described in paragraphs [0034] to [0039]), compounds represented by General Formula (1) described in JP2010-084032A (in particular, compounds described in paragraphs [0067] to [0073]), and compounds represented by General Formula (1) described in JP2016-081035A (in particular, compounds described in paragraphs [0043] to [0055]).

The retardation layer 30 preferably includes an optically anisotropic layer other than the above-described λ/4 plate.

The optically anisotropic layer is preferably an optically anisotropic layer having a phase difference in a thickness direction, more preferably a C-plate, and still more preferably a positive C-plate.

Rth(450) of the optically anisotropic layer is preferably −140 to −40 nm, more preferably −120 to −60 nm, and still more preferably −120 to −70 nm.

Rth(550) of the optically anisotropic layer is preferably −120 to −20 nm, more preferably −110 to −40 nm, and still more preferably −100 to −50 nm.

Rth(650) of the optically anisotropic layer is preferably −110 to −10 nm, more preferably −100 to −30 nm, and still more preferably −90 to −60 nm.

The optically anisotropic layer may have forward wavelength dispersibility or reverse wavelength dispersibility, and it is preferable to have forward wavelength dispersibility.

A thickness of the optically anisotropic layer is preferably 10.0 μm or less, more preferably 0.1 to 5.0 μm, and still more preferably 0.3 to 2.0 μm.

Examples of a manufacturing method of the optically anisotropic layer include a method of vertically aligning a rod-like polymerizable liquid crystal compound. Examples thereof include a manufacturing method of a positive C-plate, described in JP2017-187732A, JP2016-053709A, and JP2015-200861A.

### <Image Display Element>

The image display device 10 includes the image display element 40.

The image display element 40 is a display element including a pair of electrodes and a light emitting layer interposed between the pair of electrodes.

A reflective phase difference of the image display element 40 may have forward wavelength dispersibility or reverse wavelength dispersibility, and it is preferable to have reverse wavelength dispersibility.

Examples of the image display element 40 include an organic EL display element, a micro LED display element, and a plasma display element; and an organic EL display element or a micro LED display element is preferable.

Between the electrodes of the image display element 40, in addition to the light emitting layer, a layer such as a hole injection layer, a hole transport layer, an electron injection layer, an electron transport layer, and a protective layer may be provided; and each of these layers may have other functions. Various materials can be used for forming the respective layers.

In addition, the image display element 40 is an element which does not include a member for optical compensation on the image display surface.

The image display element 40 may function as a C-plate. Examples of the C-plate include the positive C-plate and the negative C-plate as described above.

In addition, the image display element 40 may have optical characteristics which vary depending on the wavelength, and may exhibit characteristics of negative C-plate on a short-wavelength side (for example, a wavelength of 450 nm and a wavelength of 550 nm) and exhibit characteristics of positive C-plate on a long-wavelength side (for example, a wavelength of 650 nm).

### <Other Members>

The image display device may include a member other than the above-described members.

Examples of other members include an adhesion layer and an alignment film. It is preferable that the image display device includes an adhesion layer between the members.

Examples of the adhesion layer include a known pressure sensitive adhesive layer and a known adhesive layer.

A known alignment film can be used as the alignment film.

In addition, the image display element may include a touch panel layer, or a touch panel layer may be additionally laminated on the image display element unless the image display element is built with the touch panel layer.

Furthermore, the image display device may include a cover glass on an outermost surface closest to the viewing side with respect to the polarizer.

### [Relational Expression]

The image display device according to the embodiment of the present invention satisfies relationships of expressions (1) to (9).

FIG. 4 is a view showing a relationship between terms in expressions (1) to (3).

In FIG. 4, the retardation layer 30 has the in-plane slow axis SA in a direction parallel to the x-axis and the in-plane fast axis FA in a direction parallel to the y-axis.

R₄₅₀(0) is an in-plane retardation of the retardation layer 30 at a wavelength of 450 nm, that is, an in-plane retardation (Re(450)) of the retardation layer 30 in a direction (direction parallel to the z-axis direction) indicated by a white arrow in FIG. 4, corresponding to a normal direction to a surface of the retardation layer 30. That is, R₄₅₀(0) is an in-plane retardation (Re(450)) of the retardation layer 30, which is measured from a normal direction to the surface of the retardation layer 30.

In addition, Rf₄₅₀(45) is a phase difference of the retardation layer 30 at a wavelength of 450 nm, which is measured from a first direction (see a black broken line in FIG. 4) that is a direction tilted by a polar angle φf (φf=45°) with respect to a normal direction (direction indicated by a white arrow in FIG. 4) to the surface of the retardation layer 30 with the in-plane fast axis FA of the retardation layer 30 as a rotation axis, as indicated by a black line arrow. On the other hand, Rs₄₅₀(45) is a phase difference of the retardation layer 30 at a wavelength of 450 nm, which is measured from a third direction (see a black one-dot broken line in FIG. 4) that is a direction tilted by a polar angle φs (φs=45°) with respect to the normal direction (direction indicated by a white arrow in FIG. 4) to the surface of the retardation layer 30 with the in-plane slow axis SA of the retardation layer 30 as a rotation axis, as indicated by a black line arrow.

In the following description, the relationship between the terms in the expressions (1) to (3) will be described in detail, but the relationship between the terms in the expressions (4) to (9) is the same as the relationship between the above-described terms except that the measurement wavelength is different.

### <Relationship of Expressions (1) to (3)>

$${α}_{450} = {R}_{450} ( 0 ) - \{ R {f}_{450} ( 45 ) + ( R {f}_{450} ( 45 ) M / 2 ) \} \qquad Expression ( 1 )$$

α₄₅₀ of the expression (1) means a difference between the total phase difference of the phase difference (Rf₄₅₀(45)) of the retardation layer measured from the first direction at a wavelength of 450 nm and a half of the phase difference (Rf₄₅₀(45)M) of the image display element at a wavelength of 450 nm, and the in-plane retardation (R₄₅₀(0)) of the retardation layer. As the value of α₄₅₀ is smaller, the tint difference between the tint in the front direction of the image display device and the tint in the first direction of the image display device is smaller.

R₄₅₀(0) represents an in-plane retardation of the retardation layer at a wavelength of 450 nm.

In other words, R₄₅₀(0) is an in-plane retardation (Re(450)) of the retardation layer at a wavelength of 450 nm, which is measured from the normal direction (thickness direction of the retardation layer) to the surface of the retardation layer.

R₄₅₀(0) is preferably 90 to 135 nm, more preferably 90 to 125 nm, and still more preferably 100 to 120 nm.

R₄₅₀(0) can be measured using, for example, AxoScan (manufactured by Axometrics, Inc.).

Rf₄₅₀(45) represents the phase difference of the retardation layer at a wavelength of 450 nm, which is measured from the first direction that is a direction tilted by a polar angle of 45° with respect to the normal direction to the retardation layer with the in-plane fast axis of the retardation layer as a rotation axis.

Rf₄₅₀(45) is the phase difference of the retardation layer at a wavelength of 450 nm, which is measured from the above-described first direction, and it is preferably a total value of phase differences of each layer constituting the retardation layer at a wavelength of 450 nm measured from the above-described first direction. For example, in a case where the retardation layer is composed of a first layer, a second layer, a third layer, . . . , and an n-th layer, it is preferable that Rf₄₅₀(45) is a total value of a phase difference of the first layer at the wavelength of 450 nm, a phase difference of the second layer at the wavelength of 450 nm, a phase difference of the third layer at the wavelength of 450 nm, . . . , and a phase difference of the n-th layer at the wavelength of 450 nm.

Specifically, in a case where the retardation layer in the image display device includes the λ/4 plate and the optically anisotropic layer, Rf₄₅₀(45) is obtained from a phase difference of the λ/4 plate measured from the first direction and a phase difference of the optically anisotropic layer measured from the first direction.

Rf₄₅₀(45) is preferably 90 to 180 nm, more preferably 100 to 160 nm, and still more preferably 110 to 140 nm.

Rf₄₅₀(45) can be measured using, for example, AxoScan (manufactured by Axometrics, Inc.).

Rf₄₅₀(45)M represents a phase difference at a wavelength of 450 nm, which is calculated from a change in polarization state between measurement light and reflected light reflected by the image display element, in a case where the measurement light is incident on the image display element from the first direction and the reflected light is received. Here, when the phase difference at the wavelength of 450 nm is measured, in a case where a plane including the first direction and a normal direction to a surface of the image display element is defined as a first plane, a direction tilted by a polar angle of 45° with respect to the normal direction to the surface of the image display element at an azimuthal angle deviated by 180° from an azimuthal angle of the first direction is defined as a second direction, and a plane having the second direction as a normal direction is defined as a second plane, as a slow axis is indicated in a direction parallel to the first plane in the second plane, a value of the phase difference represented by Rf₄₅₀(45)M is represented by a positive value, and as a slow axis is indicated in a direction orthogonal to the first plane in the second plane, a value of the phase difference represented by Rf₄₅₀(45)M is represented by a negative value.

The half of Rf₄₅₀(45)M is a phase difference at a wavelength of 450 nm, corresponding to either a forward path or a return path of light upon reflection at the image display element. Here, it is assumed that the phase difference of the forward path and the phase difference of the return path have the same value.

In addition, a measurement object in a case of measuring Rf₄₅₀(45)M is not particularly limited, and may be the image display element alone. In a case where the measurement object is the image display element alone, the above-described first direction in which the measurement light is incident on the image display element is a direction corresponding to the first direction in the retardation layer of the image display device assumed in a case where the image display device is produced using the image display element, the above-described retardation layer, and the like. In other words, the measurement light incident on the image display element alone is incident on the image display element alone obtained without changing the positional relationship with the retardation layer from a direction corresponding to the first direction of the retardation layer in the image display device including the image display element, in a direction corresponding to the first direction. Furthermore, a method of obtaining the image display element alone is not particularly limited, and may be a method of producing the image display element alone or a method of removing the image display element from the image display device.

“1/2” in “Rf₄₅₀(45)M/2” of the expression (1) will be described.

The phase difference of Rf₄₅₀(45)M (reflective phase difference) is measured by causing the measurement light to be incident on the image display element from the first direction and receiving the reflected light reflected by the image display element, according to a measurement method described later. In addition, it is assumed that most of the measurement light is reflected in an electrode portion in the image display element (between an incident surface side and a surface on an opposite side of the image display element), and in this case, the light to be received is substantially transmitted twice in total through the image display element in the forward path before reflection and the return path after reflection, so that the measured phase difference is also affected by the phase difference of the image display element twice. In addition, even in a case where the reflection occurs at the surface of the display element, the situation can be regarded as a case where, in the above description, the film thicknesses of the surface and the internal reflective layer become infinitesimally thin, and thus it can be treated in the same manner. Therefore, the phase difference measured in the above-described measurement method corresponds to twice the phase difference corresponding to the forward path or the return path of the reflection in the image display element, and in a case of being used in the calculation expressions (1) to (9), it is used in combination with an optically anisotropic layer assuming one degree of transmission, and thus, as the phase difference of the image display element, a half of the measured value, that is, a value of “Rf₄₅₀(45)M/2” is used. The same applies to each of the following expressions.

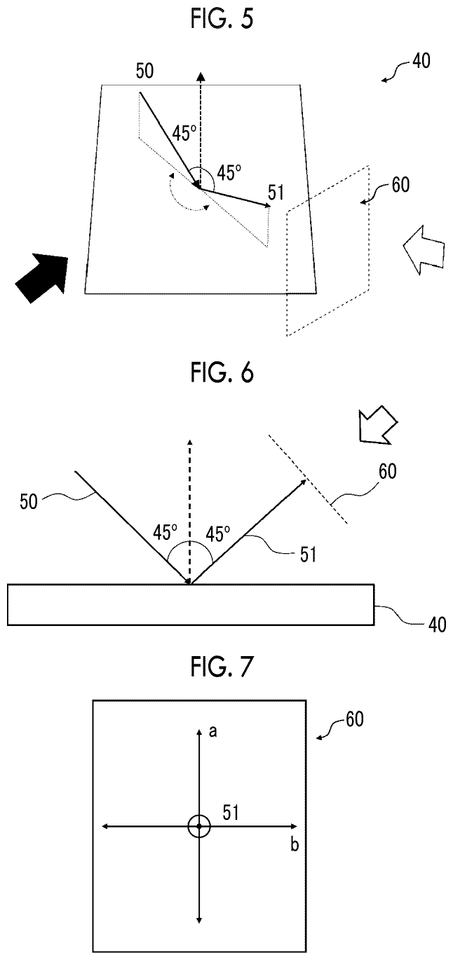

FIG. 5 is a view for describing the positive value or negative value of Rf₄₅₀(45)M.

The positive value or negative value of Rf₄₅₀(45)M is determined by the slow axis on a specific plane in a case where the phase difference at a wavelength of 450 nm is measured, as described above.

In FIG. 5, in a case where a plane including a first direction 50 (polar angle of 45°) of the image display element 40 and the normal direction to the surface of the image display element is defined as a first plane (not shown), a direction tilted by a polar angle of 45° with respect to the normal direction to the surface of the image display element at an azimuthal angle deviated by 180° from an azimuthal angle of the first direction 50, as shown by a black one-dot broken line, is defined as a second direction 51, and a plane having the second direction 51 as a normal direction is defined as a second plane 60, as a slow axis is indicated in a direction parallel to the first plane in the second plane 60, a value of the phase difference represented by Rf₄₅₀(45)M is represented by a positive value, and as a slow axis is indicated in a direction orthogonal to the first plane in the second plane 60, a value of the phase difference represented by Rf₄₅₀(45)M is represented by a negative value.

FIG. 6 shows a view as viewed in a direction of a black arrow in FIG. 5, and FIG. 7 shows a view as viewed in a direction of a white arrow in FIG. 5.

FIG. 6 is a view as viewed in a direction of the black arrow in FIG. 5.

In FIG. 6, an angle between the first direction 50 and the second direction 51 is 90°, and the second plane 60 having the second direction 51 as a normal direction is shown. The first direction 50, the second direction 51, and the normal direction shown in FIG. 6 are included in the same plane (first plane), and the direction of the black arrow shown in FIG. 5 is parallel to the normal direction of the first plane. That is, in the first plane including the first direction 50 and the normal direction to the surface of the image display element 40, a direction forming an angle of 90° with the first direction 50 corresponds to the second direction 51.

Next, FIG. 7 shows a view as viewed in a direction of a white arrow in FIGS. 5 and 6.

In FIG. 7, the second direction 51 is shown to be disposed at a center of the second plane 60. Here, when the phase difference represented by Rf₄₅₀(45)M is measured, in a case where the slow axis is indicated in a direction (corresponding to an a-axis direction in FIG. 7) parallel to the first plane in the second plane 60 (in a case of showing the highest refractive index), the value of Rf₄₅₀(45)M is represented by a positive value. On the other hand, when the phase difference represented by Rf₄₅₀(45)M is measured, in a case where the slow axis is indicated in a direction (corresponding to a b-axis direction in FIG. 7) orthogonal to the first plane in the second plane 60 (in a case of showing the highest refractive index), the value of Rf₄₅₀(45)M is represented by a negative value. For example, when the phase difference of the image display element at a wavelength of 450 nm is measured according to the above-described procedure, in a case where the magnitude (absolute value) of the phase difference is 20 nm and the slow axis is indicated in a direction (corresponding to the a-axis direction in FIG. 7) parallel to the first plane, the phase difference is +20 nm. The direction of the slow axis in the second plane can be determined from an analysis result obtained by a reflection-type spectroscopic ellipsometer described later. It is preferable that a receiver is disposed on the second direction in a case of performing the analysis obtained by the reflection-type spectroscopic ellipsometer.

Rf₄₅₀(45)M is preferably −50 to 50 nm, more preferably −30 to 20 nm, and still more preferably −25 to −5 nm.

Rf₄₅₀(45)M can be measured using, for example, a reflection-type spectroscopic ellipsometer.

In addition, in a case of measuring Rf₄₅₀(45)M, an isotropic refractive index layer may be provided on the surface of the image display element. In addition, in this case, it is desirable that a surface of the isotropic refractive index layer is smooth. In a case where the above-described smooth isotropic refractive index layer is provided, Rf₄₅₀(45)M can be easily measured with high accuracy even in an air environment.

Examples of the isotropic refractive index layer include a member made of synthetic quartz, fused quartz, or the like. In addition, it is preferable that the isotropic refractive index layer is laminated on the surface of the image display element through an adjustment layer such as an index-matching oil and a pressure sensitive adhesive.

In addition, in order to reduce influence of reflection at an interface between the surface of the isotropic refractive index layer and air or at an interface between the above-described adjustment layer and another layer in contact with the adjustment layer (for example, the image display element, fused quartz, and the like), a thickness of the isotropic refractive index layer may be increased, the image display element may be inclined by 0.5° or more within a measurable range, the light source or the receiver may be shifted by 0.5° or more in the polar angle direction, or the light source or the receiver may be shifted by 0.5° or more in the azimuthal angle direction.

$${β}_{450} = {R}_{450} ( 0 ) - \{ R {s}_{450} ( 45 ) - ( R {s}_{450} ( 45 ) M / 2 ) \} \qquad Expression ( 2 )$$

β₄₅₀ of the expression (2) means a difference between the total phase difference of the phase difference of the retardation layer measured from the third direction at a wavelength of 450 nm and a half of the phase difference of the image display element at a wavelength of 450 nm, and the in-plane retardation of the retardation layer. As the value of β₄₅₀ is smaller, the tint difference between the tint in the front direction of the image display device and the tint in the third direction of the image display device is smaller.

R₄₅₀(0) of the expression (2) has the same meaning as R₄₅₀(0) of the expression (1), and a suitable aspect thereof is also the same.

Rs₄₅₀ (45) represents the phase difference of the retardation layer at a wavelength of 450 nm, which is measured from the third direction that is a direction tilted by a polar angle of 45° with respect to the normal direction to the retardation layer with the in-plane slow axis of the retardation layer as a rotation axis.

Rs₄₅₀ (45) is the phase difference of the retardation layer at a wavelength of 450 nm, which is measured from the above-described third direction, and it is preferably a total value of phase differences of each layer constituting the retardation layer at a wavelength of 450 nm measured from the above-described third direction. For example, in a case where the retardation layer is composed of a first layer, a second layer, a third layer, . . . , and an n-th layer, it is preferable that Rs₄₅₀(45) is a total value of a phase difference of the first layer at the wavelength of 450 nm, a phase difference of the second layer at the wavelength of 450 nm, a phase difference of the third layer at the wavelength of 450 nm, . . . , and a phase difference of the n-th layer at the wavelength of 450 nm.

Specifically, in a case where the retardation layer in the image display device includes the λ/4 plate and the optically anisotropic layer, Rs₄₅₀(45) is obtained from a phase difference of the λ/4 plate measured from the third direction and a phase difference of the optically anisotropic layer measured from the third direction.

Rs₄₅₀ (45) is preferably 80 to 140 nm, more preferably 90 to 130 nm, and still more preferably 100 to 120 nm.

Rs₄₅₀ (45) can be measured using, for example, AxoScan (manufactured by Axometrics, Inc.).

Rs₄₅₀(45)M represents a phase difference at a wavelength of 450 nm, which is calculated from a change in polarization state between measurement light and reflected light reflected by the image display element, in a case where the measurement light is incident on the image display element from the third direction and the reflected light is received. Here, when the phase difference at the wavelength of 450 nm is measured, in a case where a plane including the third direction and the normal direction to the surface of the image display element is defined as a third plane, a direction tilted by a polar angle of 45° with respect to the normal direction to the surface of the image display element at an azimuthal angle deviated by 180° from an azimuthal angle of the third direction is defined as a fourth direction, and a plane having the fourth direction as a normal direction is defined as a fourth plane, as a slow axis is indicated in a direction parallel to the third plane in the fourth plane, a value of the phase difference represented by Rs₄₅₀(45)M is represented by a positive value, and as a slow axis is indicated in a direction orthogonal to the third plane in the fourth plane, a value of the phase difference represented by Rs₄₅₀(45)M is represented by a negative value.

Rs₄₅₀(45)M is preferably −50 to 50 nm, more preferably −30 to 20 nm, and still more preferably −25 to −5 nm.

The positive value or negative value of the phase difference represented by Rs₄₅₀(45)M is determined by the same method as the positive value or negative value of the phase difference represented by Rf₄₅₀(45)M. In addition, the measurement method of Rs₄₅₀(45)M can be measured by the same measurement method as the measurement method of Rf₄₅₀(45)M, except that the first direction is changed to the third direction and the second direction is changed to the fourth direction.

$$\vert {α}_{450} \vert + \vert {β}_{450} \vert \leq 4. nm \qquad Expression ( 3 )$$

The left side of the expression (3) represents a total value of an absolute value of α₄₅₀ and an absolute value of β₄₅₀, and in a case where the total value is 4.0 nm or less, the tint difference is reduced.

|α₄₅₀| is preferably 0 to 4.0 nm, more preferably 0 to 3.0 nm, and still more preferably 0 to 2.5 nm.

|β₄₅₀| is preferably 0 to 4.0 nm, more preferably 0 to 3.0 nm, and still more preferably 0 to 2.0 nm.

Among these, it is preferable to satisfy a relationship of an expression (3-1), and it is more preferable to satisfy a relationship of an expression (3-2).

$$0 nm \leq \vert {α}_{450} \vert + \vert {β}_{450} \vert \leq 3.5 nm \qquad Expression ( 3 - 1 )$$

$$0 nm \leq \vert {α}_{450} \vert + \vert {β}_{450} \vert \leq 3. nm \qquad Expression ( 3 - 2 )$$

Examples of a method of adjusting the values of α₄₅₀ and β₄₅₀ include a method of adjusting refractive index anisotropy (Δn) or d (d is a film thickness of the liquid crystal layer) in the optically anisotropic layer described later.

### <Relationship of Expressions (4) to (6)>

$${α}_{550} = {R}_{550} ( 0 ) - \{ R {f}_{550} ( 45 ) + ( R {f}_{550} ( 45 ) M / 2 ) \} \qquad Expression ( 4 )$$

Each term in α₅₅₀ of the expression (4) has the same meaning as each term in α₄₅₀, except that the measurement wavelength is changed to a wavelength of 550 nm, and the measurement method thereof is also the same.

R₅₅₀(0) is preferably 100 to 180 nm, more preferably 120 to 160 nm, and still more preferably 130 to 150 nm.

As Rf₅₅₀(45), in a case where the retardation layer in the image display device includes the λ/4 plate and the optically anisotropic layer, Rf₅₅₀(45) is obtained from a phase difference of the λ/4 plate measured from the first direction and a phase difference of the optically anisotropic layer measured from the first direction.

Rf₅₅₀(45) is preferably 90 to 180 nm, more preferably 100 to 170 nm, and still more preferably 130 to 160 nm.

Rf₅₅₀(45)M is preferably −50 to 50 nm, more preferably −30 to 20 nm, and still more preferably −15 to 5 nm.

$${β}_{550} = {R}_{550} ( 0 ) - \{ R {s}_{550} ( 45 ) - ( R {s}_{550} ( 45 ) M / 2 ) \} \qquad Expression ( 5 )$$

Each term in β₅₅₀ of the expression (5) has the same meaning as each term in β₄₅₀, except that the measurement wavelength is changed to a wavelength of 550 nm, and the measurement method thereof is also the same.

R₅₅₀(0) of the expression (5) has the same meaning as R₅₅₀(0) of the expression (4), and a suitable aspect thereof is also the same.

As Rs₅₅₀(45), in a case where the retardation layer in the image display device includes the λ/4 plate and the optically anisotropic layer, Rs₅₅₀(45) is obtained from a phase difference of the λ/4 plate measured from the third direction and a phase difference of the optically anisotropic layer measured from the third direction.

Rs₅₅₀(45) is preferably 110 to 170 nm, more preferably 120 to 160 nm, and still more preferably 130 to 150 nm.

Rs₅₅₀(45)M is preferably −50 to 50 nm, more preferably −30 to 20 nm, and still more preferably −15 to 5 nm.

$$\vert \begin{matrix}\vert {α}_{550} \vert + \vert {β}_{550} \vert \leq 4.1 nm & Expression ( 6 ) )\end{matrix}$$

The left side of the expression (6) represents a total value of an absolute value of α₅₅₀ and an absolute value of β₅₅₀, and in a case where the total value is 4.1 nm or less, the tint difference is reduced.

|α₅₅₀| is preferably 0 to 4.1 nm, more preferably 0 to 3.0 nm, still more preferably 0 to 2.5 nm, and particularly preferably 0 to 1.0 nm.

|β₅₅₀| is preferably 0 to 4.1 nm, more preferably 0 to 3.0 nm, still more preferably 0 to 2.0 nm, and particularly preferably 0 to 1.0 nm.

Among these, it is preferable to satisfy a relationship of an expression (6-1), it is more preferable to satisfy a relationship of an expression (6-2), and it is still more preferable to satisfy a relationship of an expression (6-3).

$$0 nm \leq \vert {α}_{550} \vert + \vert {β}_{550} \vert \leq 3.5 nm \qquad Expression ( 6 - 1 )$$

$$0 nm \leq \vert {α}_{550} \vert + \vert {β}_{550} \vert \leq 3. nm \qquad Expression ( 6 - 2 )$$

$$0 nm \leq \vert {α}_{550} \vert + \vert {β}_{550} \vert \leq 1. nm \qquad Expression ( 6 - 3 )$$

Examples of a method of adjusting the values of α₅₅₀ and β₅₅₀ include a method of adjusting refractive index anisotropy (Δn) or d (d is a film thickness of the liquid crystal layer) in the optically anisotropic layer described later.

### <Relationship of Expressions (7) to (9)>

$${α}_{650} = {R}_{650} ( 0 ) - \{ R {f}_{650} ( 45 ) + ( R {f}_{650} ( 45 ) M / 2 ) \} \qquad Expression ( 7 )$$

Each term in α₆₅₀ the expression (7) as the same meaning as each term in α₄₅₀, except that the measurement wavelength is changed to a wavelength of 650 nm, and the measurement method thereof is also the same.

R₆₅₀(0) is preferably 100 to 190 nm, more preferably 120 to 180 nm, and still more preferably 130 to 170 nm.

As Rf₆₅₀(45), in a case where the retardation layer in the image display device includes the λ/4 plate and the optically anisotropic layer, Rf₆₅₀(45) is obtained from a phase difference of the λ/4 plate measured from the first direction and a phase difference of the optically anisotropic layer measured from the first direction.

Rf₆₅₀(45) is preferably 90 to 180 nm, more preferably 100 to 170 nm, and still more preferably 130 to 160 nm.

Rf₆₅₀(45)M is preferably −50 to 50 nm, more preferably −30 to 20 nm, and still more preferably −10 to 10 nm.

$${β}_{650} = {R}_{650} ( 0 ) - \{ R {s}_{650} ( 45 ) - ( R {s}_{650} ( 45 ) M / 2 ) \} \qquad Expression ( 8 )$$

Each term in β₆₅₀ of the expression (8) has the same meaning as each term in β₄₅₀, except that the measurement wavelength is changed to a wavelength of 650 nm, and the measurement method thereof is also the same.

R₆₅₀(0) of the expression (8) has the same meaning as R₆₅₀(0) of the expression (7), and a suitable aspect thereof is also the same.

As Rs₆₅₀(45), in a case where the retardation layer in the image display device includes the λ/4 plate and the optically anisotropic layer, Rs₆₅₀(45) is obtained from a phase difference of the λ/4 plate measured from the third direction and a phase difference of the optically anisotropic layer measured from the third direction.

Rs₆₅₀(45) is preferably 140 to 180 nm, more preferably 150 to 170 nm, and still more preferably 140 to 160 nm.

Rs₆₅₀(45)M is preferably −50 to 50 nm, more preferably −30 to 20 nm, and still more preferably −10 to 10 nm.

$$\vert {α}_{650} \vert + \vert {β}_{650} \vert \leq 4. nm \qquad Expression ( 9 )$$

The left side of the expression (9) represents a total value of an absolute value of α₆₅₀ and an absolute value of β₆₅₀, and in a case where the total value is 4.0 nm or less, the tint difference is reduced.

|α₆₅₀| is preferably 0 to 4.0 nm, more preferably 0 to 3.0 nm, still more preferably 0 to 2.5 nm, and particularly preferably 0 to 1.5 nm.

|β₆₅₀| is preferably 0 to 4.0 nm, more preferably 0 to 3.0 nm, still more preferably 0 to 2.0 nm, and particularly preferably 0 to 1.5 nm.

Among these, it is preferable to satisfy a relationship of an expression (9-1), and it is more preferable to satisfy a relationship of an expression (9-2).

$$0 nm \leq \vert {α}_{650} \vert + \vert {β}_{650} \vert \leq 3.5 nm \qquad Expression ( 9 - 1 )$$

$$0 nm \leq \vert {α}_{650} \vert + \vert {β}_{650} \vert \leq 3. nm \qquad Expression ( 9 - 2 )$$

Examples of a method of adjusting the values of α₆₅₀ and β₆₅₀ include a method of adjusting refractive index anisotropy (Δn) or d (d is a film thickness of the liquid crystal layer) in the optically anisotropic layer described later.

The image display device preferably includes a polarizer, an A-plate, a C-plate, and an image display element in this order.

As a suitable aspect of the image display device, it is preferable that both Rf₄₅₀(45)M and Rs₄₅₀(45)M are −25 to −5 nm, both Rf₅₅₀(45)M and Rs₅₅₀(45)M are −15 to 5 nm, and both Rf₆₅₀(45)M and Rs₆₅₀(45)M are −10 to 10 nm.

As another suitable aspect of the image display device, it is preferable to further satisfy the relationship of the expression (3-1), the relationship of the expression (6-1), and the relationship of the expression (9-1).

### [Manufacturing Method of Image Display Device]

A manufacturing method of the image display device is not particularly limited, and a known method can be used.

Examples thereof include a method of applying a composition for forming a retardation layer, which contains a predetermined liquid crystal compound, onto a predetermined substrate to form a coating film, performing an alignment treatment on the coating film, performing a curing treatment to form a predetermined retardation layer, laminating the formed retardation layer and the polarizer through an adhesion layer to obtain a laminate, and further bonding the laminate and the image display element through an adhesion layer.

In addition, the retardation layer is preferably a layer formed of a composition for forming a retardation layer, which contains a polymerizable liquid crystal compound.

The liquid crystal compound is preferably a liquid crystal compound having a polymerizable group (hereinafter, also referred to as “polymerizable liquid crystal compound”). An appropriate polymerizable liquid crystal compound is appropriately selected for forming each retardation layer.

Examples of the polymerizable group included in the polymerizable liquid crystal compound include a (meth)acryloyl group, a vinyl group, a styryl group, and an allyl group; and a (meth)acryloyl group is preferable.

The liquid crystal compound can be classified into a rod-like type and a disk-like type. Furthermore, there are a low-molecular-weight type and a high-molecular-weight type for each of the rod-like type liquid crystal compound and the disk-like type liquid crystal compound.

The term “high-molecular-weight” refers to a compound having a degree of polymerization of 100 or more (Polymer Physics-Phase Transition Dynamics, written by Masao Doi, p. 2, published by Iwanami Shoten, 1992).

As the liquid crystal compound, a rod-like liquid crystal compound or a disk-like liquid crystal compound (discotic liquid crystal compound) is preferable. The liquid crystal compound may be any of a mixture of two or more kinds of the rod-like liquid crystal compounds, two or more kinds of the disk-like liquid crystal compounds, or a mixture of the rod-like liquid crystal compound and the disk-like liquid crystal compound.

Examples of the rod-like liquid crystal compound include liquid crystal compounds described in claim 1 of JP1999-513019A (JP-H11-513019A) and paragraphs [0026] to [0098] of JP2005-289980A.

Examples of the disk-like liquid crystal compound include liquid crystal compounds described in paragraphs [0020] to [0067] of JP2007-108732A and paragraphs [0013] to [0108] of JP2010-244038A.

As the liquid crystal compound, a rod-like liquid crystal compound is preferable.

Examples of the rod-like liquid crystal compound include azo compounds having an azo group, such as azomethine compounds and azoxy compounds, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles.

Among these, the rod-like liquid crystal compound preferably includes at least one selected from the group consisting of azo compounds and tolanes.

Examples of a method of adjusting the image display device to satisfy the relationships of the expressions (1) to (9) include a method of adjusting refractive index anisotropy (Δn) or d (d is a film thickness of the liquid crystal layer) in the above-described retardation layer (for example, the optically anisotropic layer). In general, as the refractive index anisotropy is larger, the forward wavelength dispersibility tends to be larger (Liquid Crystal Handbook (Liquid Crystal Handbook Editorial Committee, Maruzen Co., Ltd.)), and thus it is preferable to use, as the polymerizable liquid crystal compound, a polymerizable liquid crystal compound having large refractive index anisotropy or having large forward wavelength dispersibility. Specifically, as the polymerizable liquid crystal compound, it is preferable to use a polymerizable liquid crystal compound having a plurality of aromatic rings, a polymerizable liquid crystal compound having a heteroaromatic ring, a polymerizable liquid crystal compound having a cyclohexane ring, a polymerizable liquid crystal compound having a multiple bond, or a polymerizable liquid crystal compound having a fluorine atom.

A content of the polymerizable liquid crystal compound in the composition for forming a retardation layer is preferably 60% to 99% by mass and more preferably 70% to 98% by mass with respect to the total solid content of the composition for forming a retardation layer.

The solid content means a component capable of forming the retardation layer, excluding a solvent, and even in a case where a component itself is in a liquid state, such a component is regarded as the solid content.

The composition for forming a retardation layer may contain a component other than the polymerizable liquid crystal compound.

Examples of other components include a chiral agent, a polymerization initiator, a polyfunctional monomer, an alignment control agent (a vertical alignment agent and a horizontal alignment agent), a surfactant, an adhesion promoter, a plasticizer, a solvent, and a photo-alignment polymer.

The polymerization initiator is selected according to the type of polymerization reaction, and examples thereof include a thermal polymerization initiator and a photopolymerization initiator.

A content of the polymerization initiator in the composition for forming a retardation layer is preferably 0.01% to 20% by mass and more preferably 0.5% to 10% by mass with respect to the total solid content of the composition for forming a retardation layer.

Examples of a method of applying the composition for forming a retardation layer include a curtain coating method, a dip coating method, a spin coating method, a printing coating method, a spray coating method, a slot coating method, a roll coating method, a slide coating method, a blade coating method, a gravure coating method, and a wire bar method.

The alignment treatment can be performed by drying the coating film at room temperature or by heating the coating film. In a case of a thermotropic liquid crystal compound, a liquid crystal phase formed by the alignment treatment can generally be transferred by a change in temperature or pressure. In a case of a lyotropic liquid crystal compound, a liquid crystal phase formed by the alignment treatment can also be transferred by a compositional ratio such as an amount of solvent.

Conditions in a case of heating the coating film are not particularly limited, and the heating temperature is preferably 50° C. to 250° C. and more preferably 50° C. to 150° C., and the heating time is preferably 10 seconds to 10 minutes.

In addition, after the coating film is heated, the coating film may be cooled as necessary, before a curing treatment (light irradiation treatment) described later.

A method of the curing treatment performed on the coating film in which the polymerizable liquid crystal compound is aligned is not particularly limited, and examples thereof include a light irradiation treatment and a heat treatment. Among these, from the viewpoint of manufacturing suitability, a light irradiation treatment is preferable, and an ultraviolet irradiation treatment is more preferable.

Irradiation conditions of the light irradiation treatment are not particularly limited, and an irradiation amount of 50 to 1,000 mJ/cm² is preferable.

The atmosphere during the light irradiation treatment is not particularly limited, but is preferably a nitrogen atmosphere.

In the light irradiation treatment, “light” means an actinic ray or radiation, for example, an emission line spectrum of a mercury lamp, a far ultraviolet ray typified by an excimer laser, an extreme ultraviolet ray (EUV light), an X-ray, an ultraviolet ray, or an electron beam (EB). Among these, ultraviolet rays are preferable.

In a case where another retardation layer is directly formed on the retardation layer, for example, a photo-alignment polymer may be unevenly distributed on the surface of the retardation layer, and the photo-alignment polymer on the surface of the retardation layer may be aligned by light irradiation to impart an alignment restriction force.

### EXAMPLES

Hereinafter, the present invention will be described in more detail with reference to Examples.

The materials, amounts used, proportions, treatment details, treatment procedure, and the like shown in the following Examples can be appropriately changed without departing from the spirit and scope of the present invention. Therefore, the scope of the present invention is construed as being limited to Examples shown below.

### Comparative Example 1

### <Production of Image Display Element>

A commercially available smartphone (HUAWEI P40 Pro) was disassembled to remove a cover glass and a polarizing plate, and an organic EL substrate was taken out and used as an image display element.

It was confirmed from the results shown in the following tables that the above-described image display element exhibited reverse wavelength dispersibility.

### <Production of Optically Anisotropic Layer C1>

First, a first temporary support was produced by the following procedure.

The following various components were put into a mixing tank, stirred, and heated at 90° C. for 10 minutes. Thereafter, the obtained mixture was filtered through filter paper having an average pore diameter of 34 μm and a sintered metal filter having an average pore diameter of 10 μm to prepare a cellulose acylate dope. A concentration of solid contents of the cellulose acylate dope was 23.5% by mass.

Cellulose acylate dope

| | |
|---|---|
| Cellulose acylate (acetyl substitution degree: 2.86, | 100 parts by mass |
| viscosity average degree of polymerization: 310) | |
| Sugar ester compound 1 (represented by Formula (S4)) | 6.0 parts by mass |
| Sugar ester compound 2 (represented by Formula (S5)) | 2.0 parts by mass |
| Silica particle dispersion (AEROSIL R972, | 0.1 parts by mass |
| manufactured by Nippon Aerosil Co., Ltd.) | |

Solvent (methylene chloride/methanol/butanol) = 81/18/1 (mass ratio)

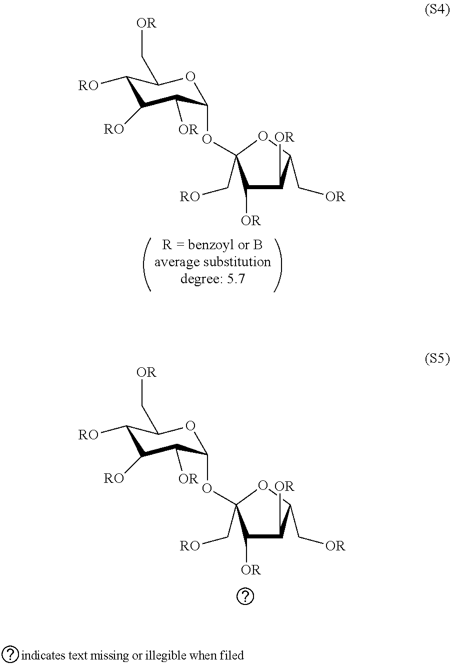

The cellulose acylate dope was cast using a drum film forming machine. The dope was cast from a die such that the dope was in contact with a metal support cooled to 0° C., and then the obtained web (film) was stripped. The drum was made of SUS.

The web obtained by casting was peeled off from the drum, and then dried in a tenter device for 20 minutes at 30° C. to 40° C. during film transport, and the tenter device transported the web by clipping both ends of the web. Next, the web was post-dried by zone heating while being rolled. After performing knurling on the obtained web, the web was wound to obtain a first temporary support (cellulose acylate film). A film thickness of the first temporary support was 40 μm.

The following liquid crystal composition 1 was applied onto the above-described first temporary support using a Giese coater to form a composition layer. The first temporary support on which the composition layer was formed was heated with hot air at 60° C. for 1 minute, and ultraviolet irradiation (irradiation amount: 120 mJ/cm², using an ultra-high pressure mercury lamp) was performed while purging with nitrogen so that an oxygen concentration was 100 ppm or less by volume, and alignment of the rod-like liquid crystal compound L-1 was fixed to form an optically anisotropic layer C1 which was a positive C-plate, thereby producing a transfer film 1 including the first temporary support and the optically anisotropic layer C1 disposed adjacent to the first temporary support.

A thickness of the optically anisotropic layer C1 was 0.6 μm, an average tilt angle of a polymer derived from the rod-like liquid crystal compound L-1 with respect to a surface of the transfer film 1 in a major axis direction of the rod-like liquid crystal compound L-1 was 90°, and the polymer was vertically aligned with respect to the surface of the transfer film 1.

Liquid crystal composition 1

| | |
|---|---|
| Rod-like liquid crystal compound L-1 shown below | 100 parts by mass |
| Polyfunctional monomer M-1 shown below | 5.0 parts by mass |
| (UA-306I, urethane acrylate monomer, | |
| manufactured by KYOEISHA | |
| CHEMICAL Co., LTD.) | |
| Polymerization initiator (Irgacure OXE01, | 4.0 parts by mass |
| manufactured by BASF) | |
| Polymer X-1 shown below | 1.2 parts by mass |
| Onium salt compound shown below | 1.14 parts by mass |
| Fluorine-containing compound (fluorine-containing | 0.4 parts by mass |
| polymer) F-1 shown below | |
| Methyl ethyl ketone | 43.3 parts by mass |
| Ethyl propionate | 95.0 parts by mass |
| Methyl isobutyl ketone | 494.9 parts by mass |

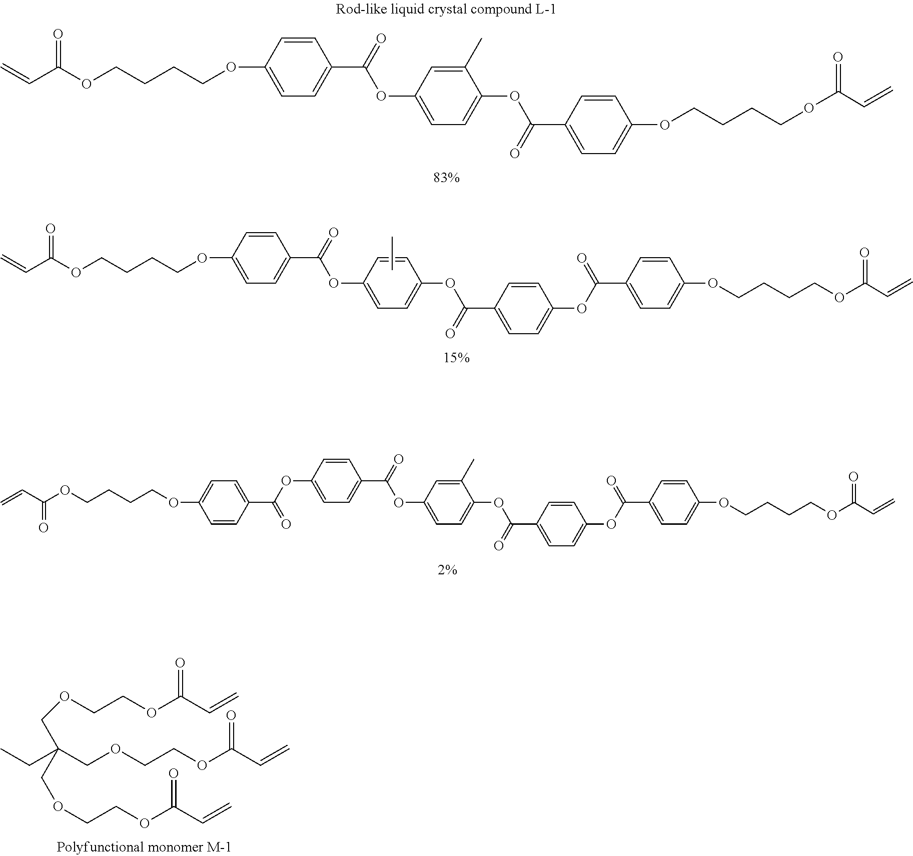

Polymer X-1 (the numerical value in the following formulae indicates the content (% by mass) of each repeating unit with respect to all repeating units in the polymer; the weight-average molecular weight is 57,000)

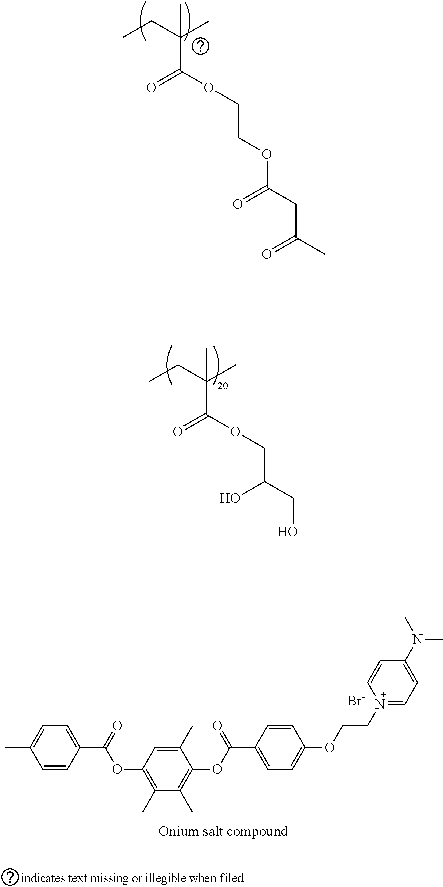

Fluorine-containing polymer F-1 (the numerical value in the following formulae indicates the content (% by mass) of each repeating unit with respect to all repeating units in the polymer; the weight-average molecular weight is 15,000)

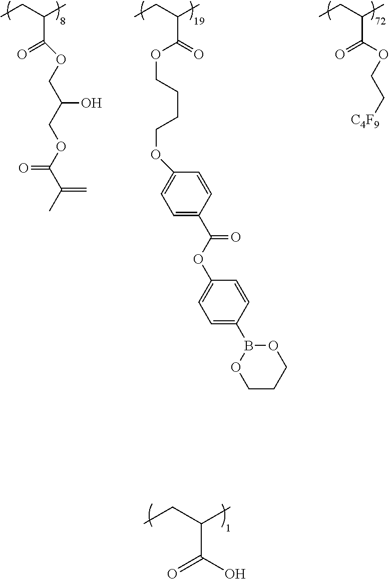

### <Production of Optically Anisotropic Layer A1>

A coating liquid E1 for forming a photo-alignment film, having the following formulation, was continuously applied onto the above-described first temporary support using a wire bar. The first temporary support on which the coating film was formed was dried with hot air at 134° C. for 75 seconds, and the coating film was irradiated with polarized ultraviolet rays (8 mJ/cm², using an ultra-high pressure mercury lamp) to form a photo-alignment film 1. A film thickness of the photo-alignment film 1 was 0.5 μm.

Coating liquid E1 for forming photo-alignment film

| | |
|---|---|
| Polymer PA-1 shown below | 100.00 parts by mass |
| Acid generator PAG-1 shown below | 6.00 parts by mass |
| DIPEA | 0.60 parts by mass |
| Butyl acetate | 625.4 parts by mass |
| Methyl ethyl ketone | 156.3 parts by mass |

Polymer PA-1 [in the formula, the numerical value described in each repeating unit denotes the content (% by mass) of each repeating unit with respect to all repeating units; weight-average molecular weight: 45,000]

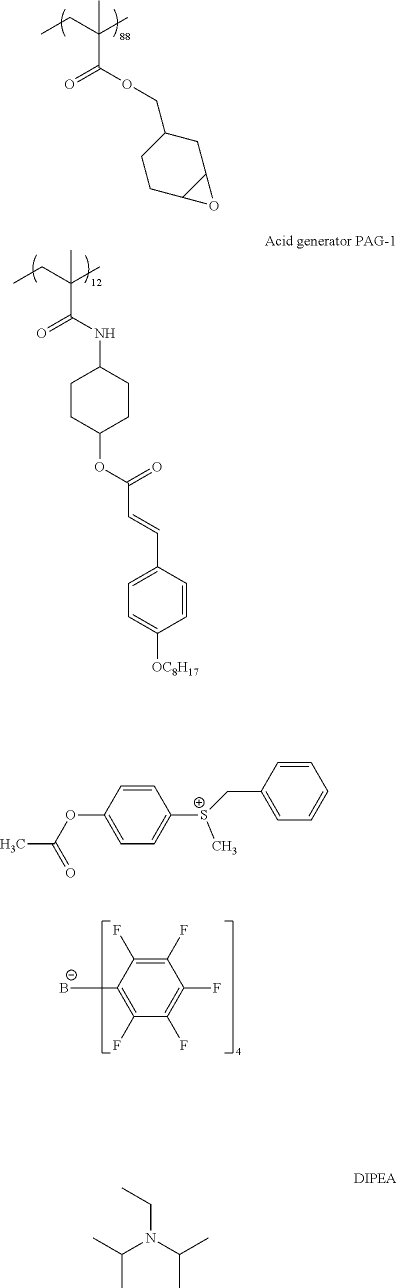

Next, the above-described photo-alignment film 1 was coated with the following composition F1 using a bar coater. The coating film formed on the photo-alignment film 1 was heated to 125° C. with hot air, cooled to 60° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic layer A1 which was a positive A-plate.

A thickness of the optically anisotropic layer A1 was 2.8 μm.

Composition F1

| | |
|---|---|
| Polymerizable liquid crystal compound | 45.36 parts by mass |
| LA-1 shown below | |
| Polymerizable liquid crystal compound | 21.84 parts by mass |
| LA-2 shown below | |
| Polymerizable liquid crystal compound | 20.00 parts by mass |
| LA-3 shown below | |
| Polymerizable liquid crystal compound | 5.00 parts by mass |
| LA-4 shown below | |
| Mixture of polymerizable liquid crystal | 7.80 parts by mass |
| compounds LA-5 shown below | |
| Polymerization initiator PI-1 shown below | 0.50 parts by mass |
| Leveling agent T-1 shown below | 0.09 parts by mass |
| Cyclopentanone | 180.73 parts by mass |
| Methyl ethyl ketone | 53.98 parts by mass |

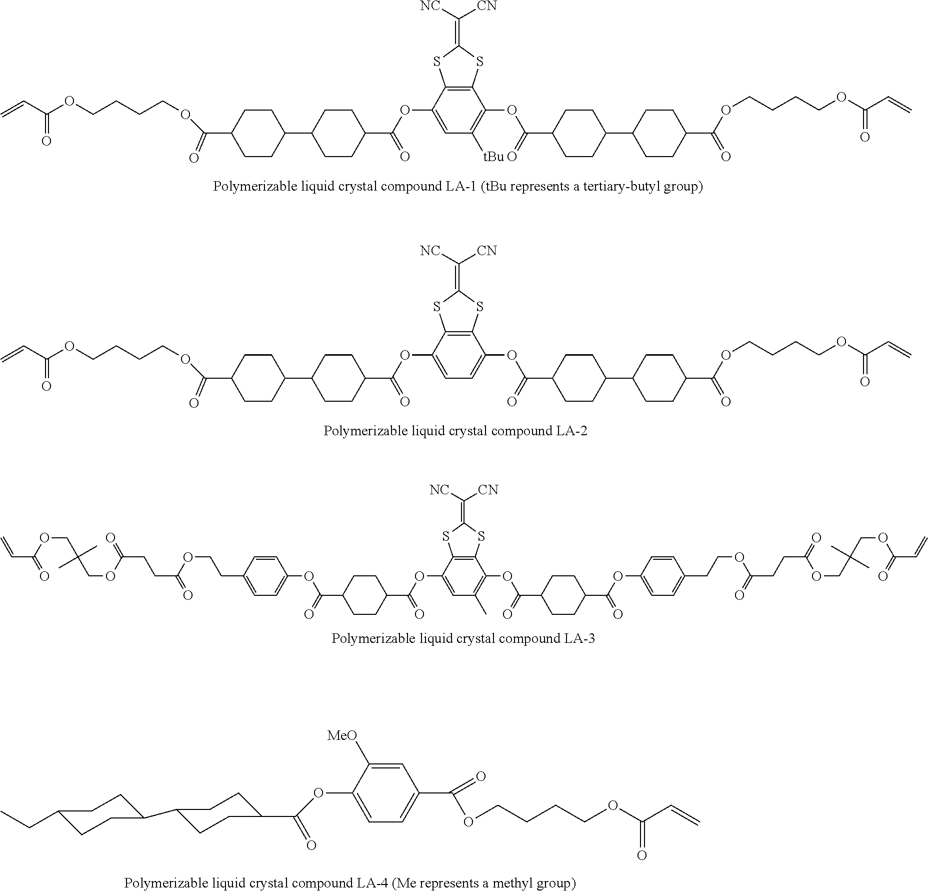

Mixture of polymerizable liquid crystal compounds LA-5 (mixture of the following liquid crystal compounds (RA), (RB), and (RC) at a mass ratio of 84:14:2)

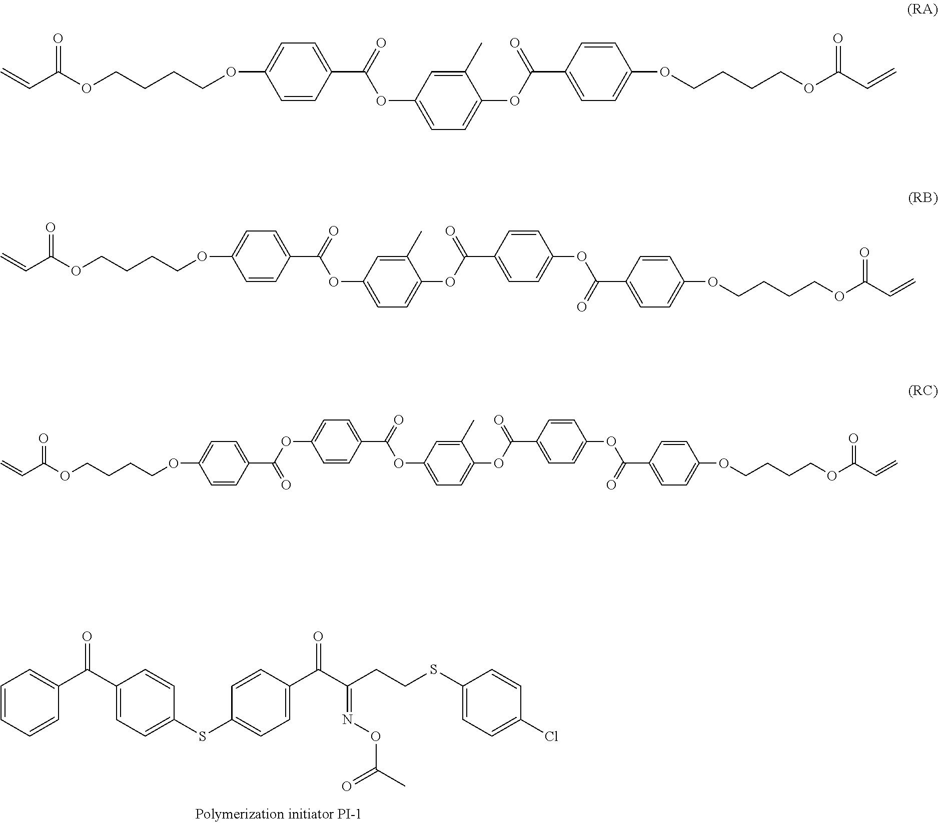

Leveling agent T-1 [in the formula, the numerical value described in each repeating unit denotes the content (% by mass) of each repeating unit with respect to all repeating units; weight-average molecular weight. 25,000]

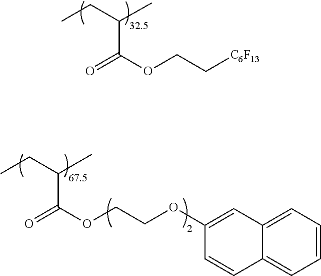

### <Polarizer>

Next, a polyvinyl alcohol film having a thickness of 80 μm was dyed by immersing the film in an iodine aqueous solution having an iodine concentration of 0.05% by mass at 30° C. for 60 seconds. Next, the obtained film was stretched in the machine direction to 5 times the original length while being immersed in a boric acid aqueous solution having a boric acid concentration of 4% by mass for 60 seconds, and then dried at 50° C. for 4 minutes to obtain a polarizer having a thickness of 20 μm.

### <Production of Image Display Device>

A pressure sensitive adhesive (SK-2057, manufactured by Soken Chemical & Engineering Co., Ltd.) was applied onto a side of the optically anisotropic layer A1 opposite to the first temporary support to form a pressure sensitive adhesive layer. Next, the exposed surface of the above-described optically anisotropic layer C1 in the transfer film 1 obtained as described above and the above-described pressure sensitive adhesive layer were bonded to each other to be in close contact with each other, and then the first temporary support and the photo-alignment film 1 were peeled off to obtain a laminate.

Next, a pressure sensitive adhesive (SK-2057, manufactured by Soken Chemical & Engineering Co., Ltd.) was applied onto one surface of the obtained polarizer to form a pressure sensitive adhesive layer, and the polarizer and the above-described laminate were bonded such that the optically anisotropic layer A1 and the polarizer in the laminate were in close contact with each other in a direction in which an in-plane slow axis of the optically anisotropic layer A1 and an absorption axis of the polarizer formed an angle of 45°. Furthermore, Corning Eagle XG glass was bonded to the optically anisotropic layer C1 side of the laminate using a pressure sensitive adhesive (SK-2057, manufactured by Soken Chemical & Engineering Co., Ltd.) to obtain an optical laminate 1.

Furthermore, the image display element was laminated on a side of the glass in the optical laminate 1 opposite to the optically anisotropic layer C1 side using a pressure sensitive adhesive (SK-2057, manufactured by Soken Chemical & Engineering Co., Ltd.) to obtain an image display device 1. The image display device 1 included the polarizer, the optically anisotropic layer A1, the optically anisotropic layer C1, the glass, and the image display element in this order from the viewing side.

It was confirmed that the glass did not affect each value in the expressions (1) to (9).

### Comparative Examples 2 to 4

Each image display device was obtained by the same method as in Comparative Example 1, except that, in Comparative Example 1, the thickness of the optically anisotropic layer C1 was changed to the value shown below.
A thickness of the optically anisotropic layer C2 was 0.70 μm.
A thickness of the optically anisotropic layer C3 was 0.87 μm.
A thickness of the optically anisotropic layer C4 was 0.90 μm.

### Comparative Example 5

An optically anisotropic layer C5 was produced by the same procedure as in Comparative Example 1, except that, in Comparative Example 1, a rod-like liquid crystal compound L-2 (100 parts by mass) was used instead of the rod-like liquid crystal compound L-1 (100 parts by mass), thereby obtaining an image display device of Comparative Example 5.

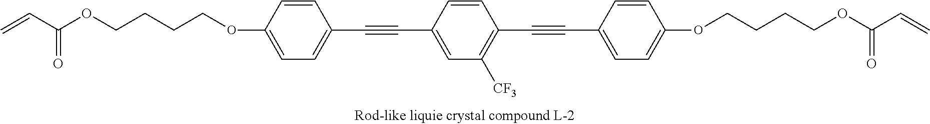 [SMILES: C=CC(=O)OCCCCOc1ccc(C#Cc2ccc(C#Cc3ccc(OCCCCOC(=O)C=C)cc3)c(C(F)(F)F)c2)cc1]

### Comparative Example 6

A circular polarization plate used in Comparative Example 30 of JP2021-076826A was prepared, and Corning Eagle XG glass was bonded to the C-plate side of the circular polarization plate using a pressure sensitive adhesive (SK-2057, manufactured by Soken Chemical & Engineering Co., Ltd.) to obtain an optical laminate. Furthermore, the image display element was laminated on a side of the glass in the obtained optical laminate opposite to the C-plate side using a matching oil, thereby obtaining an image display device of Comparative Example 6.

### Comparative Example 7

An image display device of Comparative Example 7 was obtained by the same procedure as in Comparative Example 6, except that a circular polarization plate used in Example 17 of JP2021-076826A was used instead of the circular polarization plate used in Comparative Example 30 of JP2021-076826A.

### Comparative Example 8

An image display device of Comparative Example 8 was obtained by the same procedure as in Comparative Example 6, except that a circular polarization plate used in Example 18 of JP2021-076826A was used instead of the circular polarization plate used in Comparative Example 30 of JP2021-076826A.

### Comparative Example 9

An image display device of Comparative Example 9 was obtained by the same procedure as in Comparative Example 6, except that a circular polarization plate used in Example 19 of JP2021-076826A was used instead of the circular polarization plate used in Comparative Example 30 of JP2021-076826A.

### Example 1

An optically anisotropic layer C10 was produced by the same procedure as in Comparative Example 1, except that a mixture L-3 of rod-like liquid crystal compounds (100 parts by mass) was used instead of the rod-like liquid crystal compound L-1 (100 parts by mass), and the film thickness of the optically anisotropic layer was adjusted such that the phase difference shown in Table 1 described later was obtained, thereby obtaining an image display device of Example 1.

Mixture L-3 of rod-like liquid crystal compounds

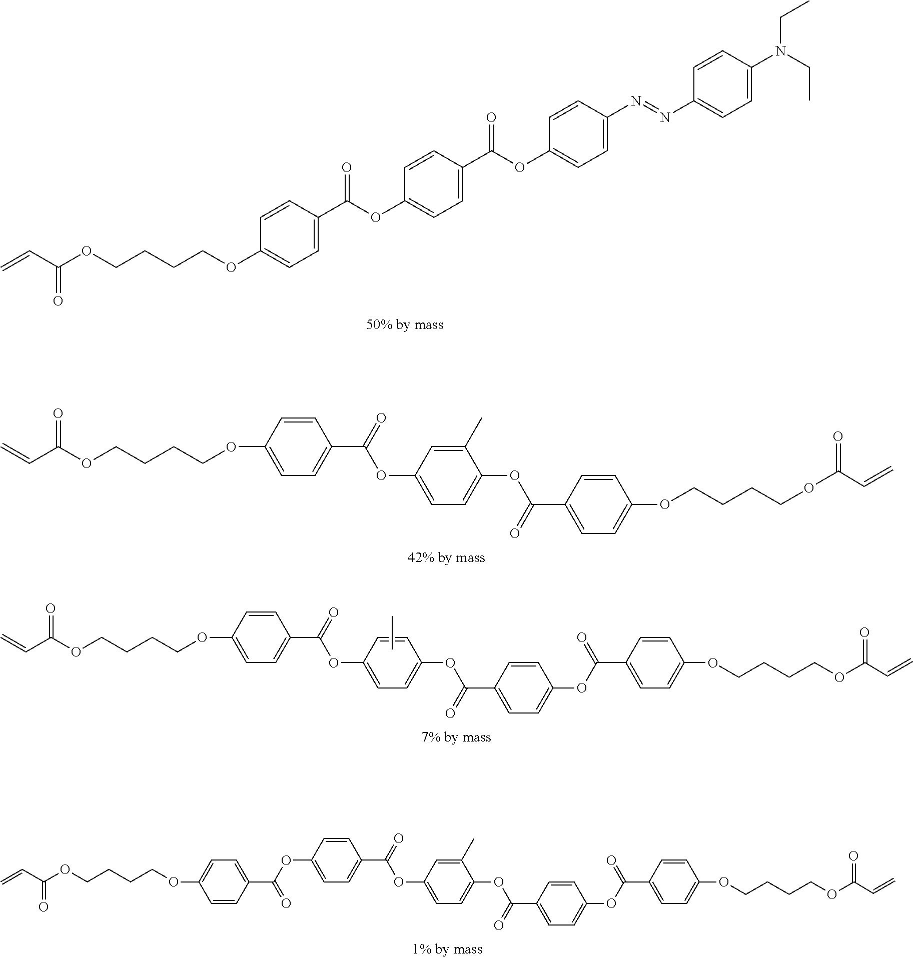

### Example 2

An optically anisotropic layer C11 was produced by the same procedure as in Comparative Example 1, except that a rod-like liquid crystal compound L-4 (100 parts by mass) was used instead of the rod-like liquid crystal compound L-1 (100 parts by mass), and the film thickness of the optically anisotropic layer was adjusted such that the phase difference shown in Table 1 described later was obtained, thereby obtaining an image display device of Example 2.

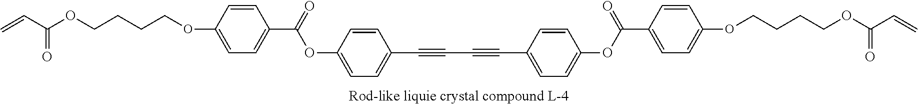 [SMILES: C=CC(=O)OCCCCOc1ccc(C(=O)Oc2ccc(C#CC#Cc3ccc(OC(=O)c4ccc(OCCCCOC(=O)C=C)cc4)cc3)cc2)cc1]

### Example 3

An optically anisotropic layer C12 was produced by the same procedure as in Comparative Example 1, except that a rod-like liquid crystal compound L-5 (100 parts by mass) was used instead of the rod-like liquid crystal compound L-1 (100 parts by mass), and the film thickness of the optically anisotropic layer was adjusted such that the phase difference shown in Table 1 described later was obtained, thereby obtaining an image display device of Example 3.

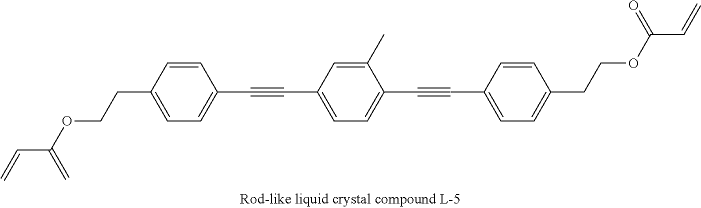 [SMILES: C=CC(=C)OCCc1ccc(C#Cc2ccc(C#Cc3ccc(CCOC(=O)C=C)cc3)c(C)c2)cc1]

An optically anisotropic layer C13 was produced by the same procedure as in Comparative Example 1, except that a rod-like liquid crystal compound L-5 (100 parts by mass) was used instead of the rod-like liquid crystal compound L-1 (100 parts by mass), and the film thickness of the optically anisotropic layer was adjusted such that the phase difference shown in Table 1 described later was obtained, thereby obtaining an image display device of Example 4.

### Example 5

An optically anisotropic layer C14 was produced by the same procedure as in Comparative Example 1, except that a rod-like liquid crystal compound L-5 (100 parts by mass) was used instead of the rod-like liquid crystal compound L-1 (100 parts by mass), and the film thickness of the optically anisotropic layer was adjusted such that the phase difference shown in Table 1 described later was obtained, thereby obtaining an image display device of Example 5.

### Example 6

An optically anisotropic layer C15 was produced by the same procedure as in Comparative Example 1, except that a rod-like liquid crystal compound L-6 (100 parts by mass) was used instead of the rod-like liquid crystal compound L-1 (100 parts by mass), and the film thickness of the optically anisotropic layer was adjusted such that the phase difference shown in Table 1 described later was obtained, thereby obtaining an image display device of Example 6.

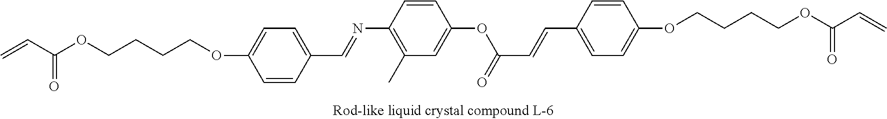 [SMILES: C=CC(=O)OCCCCOc1ccc(/C=C/C(=O)Oc2ccc(/N=C/c3ccc(OCCCCOC(=O)C=C)cc3)c(C)c2)cc1]

### [Measurement]

### <Values Related to Retardation Layer>

Using Axoscan of Axometrics, Inc., each value related to the retardation layer, the A-plate, and the C-plate, shown in the following tables, was measured by the above-described measurement methods.

### <Values Related to Image Display Element>

Fused quartz was laminated on the surface of the image display element through an index-matching oil to obtain a measurement sample. In a case where each image display device was produced using the image display element serving as a measurement object in the measurement of values related to the image display element, the measurement light was incident from a direction corresponding to the first direction or the third direction of the retardation layer.

Using a reflection-type spectroscopic ellipsometer RC2 (manufactured by J. A. Woollam Co., Ltd.), each value related to the image display element, shown in the following tables, was measured for the measurement sample.

### [Tint Difference]

A tint difference of each produced image display device was evaluated under a bright light.

The image display device was turned off (black state), and the reflected light in a case where a fluorescent lamp was reflected from three directions of the front (viewing side), a direction parallel to the in-plane fast axis of the retardation layer at a polar angle of 45°, and a direction parallel to the in-plane slow axis of the retardation layer at a polar angle of 45° was observed. Display quality at a polar angle of 45 degrees was evaluated according to the following standard as compared with the front.
“A”: tint difference was not visually recognized at all.
“B”: tint difference was slightly visually recognized.
“C”: tint difference was visually recognized, but there was no problem in use.
“D”: tint difference was visually recognized, and was not acceptable.

### [Reflection Intensity]

In [Tint difference], the intensity of the reflected light was evaluated according to the following standard in a case where the reflected light was observed from each direction from a polar angle of 45°.
“A”: reflected light was weak, and was acceptable.
“B”: reflected light was strong, and was not acceptable.

TABLE 1

| | Image display device | | | | | | | | | | | | | |
|---|---|---|---|---|---|---|---|---|---|---|---|---|---|---|
| | Retardation layer | | | | | | | | | | | | | |
| | | | | | | | | C-plate | | | | | | |
| | | | | | | | | | | | | RCf₄₅₀ | RCf₅₅₀ | RCf₆₅₀ |
| | A-plate | | | | | | | | | | | (45) | (45) | (45) |
| | | RAf₄₅₀ | RAf₅₅₀ | RAf₆₅₀ | RAs₄₅₀ | RAs₅₅₀ | RAs₆₅₀ | | Rth | Rth | Rth | RCs₄₅₀ | RCs₅₅₀ | RCs₆₅₀ |
| | Type | (45) | (45) | (45) | (45) | (45) | (45) | Type | (450) | (550) | (650) | (45) | (45) | (45) |
| Example 1 | A1 | 103.2 | 125.2 | 129.9 | 130.2 | 159.1 | 165.4 | C10 | −97.4 | −86.7 | −67.6 | 22.5 | 20.0 | 15.6 |
| Example 2 | A1 | 103.2 | 125.2 | 129.9 | 130.2 | 159.1 | 165.4 | C11 | −98.7 | −86.7 | −81.6 | 22.8 | 20.0 | 18.8 |
| Example 3 | A1 | 103.2 | 125.2 | 129.9 | 130.2 | 159.1 | 165.4 | C12 | −100.4 | −77.8 | −78.9 | 20.8 | 18.0 | 16.4 |
| Example 4 | A1 | 103.2 | 125.2 | 129.9 | 130.2 | 159.1 | 165.4 | C13 | −100.4 | −86.7 | −78.9 | 23.2 | 20.0 | 18.2 |
| Example 5 | A1 | 103.2 | 125.2 | 129.9 | 130.2 | 159.1 | 165.4 | C14 | −100.4 | −88.7 | −78.9 | 23.7 | 20.5 | 18.6 |
| Example 6 | A1 | 103.2 | 125.2 | 129.9 | 130.2 | 159.1 | 165.4 | C15 | −102.1 | −86.7 | −81.2 | 23.6 | 20.0 | 18.8 |
| Comparative | A1 | 103.2 | 125.2 | 129.9 | 130.2 | 159.1 | 165.4 | C1 | −94.6 | −65.0 | −82.9 | 16.5 | 15.1 | 14.4 |
| Example 1 | | | | | | | | | | | | | | |
| Comparative | A1 | 103.2 | 125.2 | 129.9 | 130.2 | 159.1 | 165.4 | C2 | −94.6 | −75.0 | −82.9 | 18.9 | 17.4 | 16.6 |
| Example 2 | | | | | | | | | | | | | | |
| Comparative | A1 | 103.2 | 125.2 | 129.9 | 130.2 | 159.1 | 165.4 | C3 | −94.6 | −86.7 | −82.9 | 21.8 | 20.0 | 19.1 |
| Example 3 | | | | | | | | | | | | | | |
| Comparative | A1 | 103.2 | 125.2 | 129.9 | 130.2 | 159.1 | 165.4 | C4 | −94.6 | −95.0 | −82.9 | 23.9 | 21.9 | 20.9 |
| Example 4 | | | | | | | | | | | | | | |
| Comparative | A1 | 103.2 | 125.2 | 129.9 | 130.2 | 159.1 | 165.4 | C5 | −114.5 | −86.7 | −76.7 | 26.4 | 20.0 | 17.8 |
| Example 5 | | | | | | | | | | | | | | |
| Comparative | A2 | 108.9 | 125.2 | 128.9 | 138.4 | 159.1 | 163.9 | C6 | −94.5 | −70.0 | −83.2 | 17.7 | 16.2 | 15.6 |
| Example 6 | | | | | | | | | | | | | | |
| Comparative | A3 | 108.9 | 125.2 | 128.9 | 138.4 | 159.1 | 163.9 | C7 | −94.5 | −80.0 | −83.2 | 20.2 | 18.5 | 17.8 |
| Example 7 | | | | | | | | | | | | | | |
| Comparative | A4 | 108.9 | 125.2 | 128.9 | 138.4 | 159.1 | 163.9 | C8 | −94.5 | −90.0 | −83.2 | 22.6 | 20.8 | 19.9 |
| Example 8 | | | | | | | | | | | | | | |
| Comparative | A5 | 108.9 | 125.2 | 128.9 | 138.4 | 159.1 | 163.9 | C9 | −94.5 | −10.0 | −83.2 | 2.9 | 2.7 | 2.5 |
| Example 9 | | | | | | | | | | | | | | |

TABLE 2

| | Image display device | | | | | | | | | | | |
|---|---|---|---|---|---|---|---|---|---|---|---|---|
| | | | | | | | | | | Image display element | | |
| | | | | | | | | | | Rf₄₅₀ | Rf₅₅₀ | Rf₆₅₀ |
| | Retardation layer | | | | | | | | | (45)M | (45)M | (45)M |
| | R₄₅₀ | R₅₅₀ | R₆₅₀ | Rf₄₅₀ | Rf₅₅₀ | Rf₆₅₀ | Rs₄₅₀ | Rs₅₅₀ | Rs₆₅₀ | Rs₄₅₀ | Rs₅₅₀ | Rs₆₅₀ |
| | (0) | (0) | (0) | (45) | (45) | (45) | (45) | (45) | (45) | (45)M | (45)M | (45)M |
| Example 1 | 116.4 | 142.0 | 147.5 | 125.7 | 145.2 | 145.5 | 107.7 | 139.1 | 149.8 | −16.4 | −6.1 | 1.8 |
| Example 2 | 116.4 | 142.0 | 147.5 | 126.0 | 145.2 | 148.7 | 107.4 | 139.1 | 146.6 | −16.4 | −6.1 | 1.8 |
| Example 3 | 116.4 | 142.0 | 147.5 | 124.0 | 143.2 | 146.3 | 109.4 | 141.1 | 149.0 | −16.4 | −6.1 | 1.8 |
| Example 4 | 116.4 | 142.0 | 147.5 | 126.4 | 145.2 | 148.1 | 107.0 | 139.1 | 147.2 | −16.4 | −6.1 | 1.8 |
| Example 5 | 116.4 | 142.0 | 147.5 | 126.9 | 145.7 | 148.5 | 106.5 | 138.6 | 146.8 | −16.4 | −6.1 | 1.8 |
| Example 6 | 116.4 | 142.0 | 147.5 | 126.8 | 145.2 | 148.7 | 106.6 | 139.1 | 146.6 | −16.4 | −6.1 | 1.8 |
| Comparative | 116.4 | 142.0 | 147.5 | 119.7 | 140.3 | 144.3 | 113.7 | 144.0 | 151.0 | −16.4 | −6.1 | 1.8 |
| Example 1 | | | | | | | | | | | | |
| Comparative | 116.4 | 142.0 | 147.5 | 122.1 | 142.6 | 146.5 | 111.3 | 141.7 | 148.8 | −16.4 | −6.1 | 1.8 |
| Example 2 | | | | | | | | | | | | |
| Comparative | 116.4 | 142.0 | 147.5 | 125.0 | 145.2 | 149.0 | 108.4 | 139.1 | 146.3 | −16.4 | −6.1 | 1.8 |
| Example 3 | | | | | | | | | | | | |
| Comparative | 116.4 | 142.0 | 147.5 | 127.1 | 147.1 | 150.8 | 106.3 | 137.2 | 144.5 | −16.4 | −6.1 | 1.8 |
| Example 4 | | | | | | | | | | | | |
| Comparative | 116.4 | 142.0 | 147.5 | 129.6 | 145.2 | 147.7 | 103.8 | 139.1 | 147.6 | −16.4 | −6.1 | 1.8 |
| Example 5 | | | | | | | | | | | | |
| Comparative | 123.5 | 142.0 | 146.3 | 126.6 | 141.4 | 144.5 | 120.7 | 142.9 | 148.3 | −16.4 | −6.1 | 1.8 |
| Example 6 | | | | | | | | | | | | |
| Comparative | 123.5 | 142.0 | 146.3 | 129.1 | 143.7 | 146.7 | 118.2 | 140.6 | 146.1 | −16.4 | −6.1 | 1.8 |
| Example 7 | | | | | | | | | | | | |
| Comparative | 123.5 | 142.0 | 146.3 | 131.5 | 146.0 | 148.8 | 115.8 | 138.3 | 144.0 | −16.4 | −6.1 | 1.8 |
| Example 8 | | | | | | | | | | | | |
| Comparative | 123.5 | 142.0 | 146.3 | 111.8 | 127.9 | 131.4 | 135.5 | 156.4 | 161.4 | −16.4 | −6.1 | 1.8 |
| Example 9 | | | | | | | | | | | | |

TABLE 3

| | Expres- | Expres- | Expres- | Expres- | Expres- | Expres- | Expres- | Expres- | Expres- | Evaluation result | |
|---|---|---|---|---|---|---|---|---|---|---|---|
| | sion (1) | sion (2) | sion (3) | sion (4) | sion (5) | sion (6) | sion (7) | sion (8) | sion (9) | Tint | Reflection |
| | α₄₅₀ | β₄₅₀ | \|α₄₅₀ + β₄₅₀\| | α₅₅₀ | β₅₅₀ | \|α₅₅₀ + β₅₅₀\| | α₆₅₀ | β₆₅₀ | \|α₆₅₀ + β₆₅₀\| | difference | intensity |
| Example 1 | 1.1 | 0.5 | 1.6 | 0.1 | 0.2 | 0.3 | 1.1 | 1.4 | 2.5 | A | A |
| Example 2 | 1.4 | 0.8 | 2.2 | 0.1 | 0.2 | 0.3 | 2.1 | 1.8 | 3.9 | B | A |
| Example 3 | 0.6 | 1.2 | 1.8 | 1.9 | 2.2 | 4.1 | 0.3 | 0.6 | 0.9 | B | A |
| Example 4 | 1.8 | 1.2 | 3.0 | 0.1 | 0.2 | 0.3 | 1.5 | 1.2 | 2.7 | A | A |
| Example 5 | 2.3 | 1.7 | 4.0 | 0.6 | 0.3 | 0.9 | 1.9 | 1.6 | 3.5 | B | A |
| Example 6 | 2.2 | 1.6 | 3.8 | 0.1 | 0.2 | 0.3 | 2.1 | 1.8 | 3.9 | B | A |
| Comparative | 4.9 | 5.5 | 10.4 | 4.8 | 5.1 | 9.9 | 2.3 | 2.6 | 4.9 | D | B |
| Example 1 | | | | | | | | | | | |
| Comparative | 2.5 | 3.1 | 5.6 | 2.5 | 2.8 | 5.3 | 0.1 | 0.4 | 0.5 | D | B |
| Example 2 | | | | | | | | | | | |
| Comparative | 0.4 | 0.2 | 0.6 | 0.1 | 0.2 | 0.3 | 2.4 | 2.1 | 4.5 | C | A |
| Example 3 | | | | | | | | | | | |
| Comparative | 2.5 | 1.9 | 4.4 | 2.0 | 1.8 | 3.8 | 4.2 | 3.9 | 8.1 | D | A |
| Example 4 | | | | | | | | | | | |
| Comparative | 5.0 | 4.4 | 9.4 | 0.1 | 0.2 | 0.3 | 1.1 | 0.8 | 1.9 | D | A |
| Example 5 | | | | | | | | | | | |
| Comparative | 5.1 | 5.4 | 10.5 | 3.7 | 4.0 | 7.6 | 0.9 | 1.1 | 2.0 | D | B |
| Example 6 | | | | | | | | | | | |
| Comparative | 2.6 | 2.9 | 5.5 | 1.4 | 1.7 | 3.1 | 1.3 | 1.1 | 2.4 | D | A |
| Example 7 | | | | | | | | | | | |
| Comparative | 0.2 | 0.5 | 0.7 | 0.9 | 0.7 | 1.6 | 3.4 | 3.2 | 6.6 | D | A |
| Example 8 | | | | | | | | | | | |
| Comparative | 19.9 | 20.2 | 40.1 | 17.2 | 17.5 | 34.7 | 14.0 | 14.2 | 28.2 | D | B |
| Example 9 | | | | | | | | | | | |

From the evaluation results shown in Table 3, it was found that the tint difference was small in the present invention.

From the comparison of Examples 1 to 6, it was found that, in a case where the image display device satisfied the relationship of the expression (3-1), satisfied the relationship of the expression (6-1), and satisfied the relationship of the expression (9-1), the effect of the present invention was more excellent.

### Examples 7 to 9

An optically anisotropic layer C18 was produced by the same procedure as in Comparative Example 1, except that a rod-like liquid crystal compound L-7 (100 parts by mass) was used instead of the rod-like liquid crystal compound L-1 (100 parts by mass), the film thickness of the optically anisotropic layer was adjusted such that the phase difference shown in Table 4 described later was obtained, and the glass was laminated on a non-glossy side of commercially available aluminum foil, instead of the image display device, thereby obtaining an image display device of Example 7.

The image display element of Example 7 included the polarizer, the optically anisotropic layer A1, the optically anisotropic layer C1, the glass, and the aluminum foil in this order from the viewing side.

The Rf₄₅₀(45)M and the like were measured using the non-glossy surface of the aluminum foil as the measurement surface.

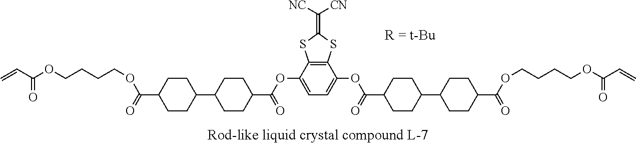 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

TABLE 4

| | Image display device | | | | | | | | | | | | | |
|---|---|---|---|---|---|---|---|---|---|---|---|---|---|---|
| | Retardation layer | | | | | | | | | | | | | |
| | | | | | | | | C-plate | | | | | | |
| | | | | | | | | | | | | RCf₄₅₀ | RCf₅₅₀ | RCf₆₅₀ |
| | A-plate | | | | | | | | | | | (45) | (45) | (45) |
| | | RAf₄₅₀ | RAf₅₅₀ | RAf₆₅₀ | RAs₄₅₀ | RAs₅₅₀ | RAs₆₅₀ | | Rth | Rth | Rth | RCs₄₅₀ | RCs₅₅₀ | RCs₆₅₀ |
| | Type | (45) | (45) | (45) | (45) | (45) | (45) | Type | (450) | (550) | (650) | (45) | (45) | (45) |
| Example 7 | A1 | 103.2 | 125.2 | 129.9 | 130.2 | 159.1 | 165.4 | C18 | −59.7 | −40.0 | −93.4 | 6.5 | 9.4 | 10.2 |
| Example 8 | A1 | 103.2 | 125.2 | 129.9 | 130.2 | 159.1 | 165.4 | C19 | −59.7 | −48.0 | −93.4 | 7.8 | 11.3 | 12.1 |
| Example 9 | A1 | 103.2 | 125.2 | 129.9 | 130.2 | 159.1 | 165.4 | C20 | −59.7 | −50.0 | −93.4 | 8.1 | 11.7 | 12.6 |

TABLE 5

| | Image display device | | | | | | | | | | | |
|---|---|---|---|---|---|---|---|---|---|---|---|---|
| | | | | | | | | | | Image display element | | |
| | | | | | | | | | | Rf₄₅₀ | Rf₃₅₀ | Rf₆₅₀ |
| | Retardation layer | | | | | | | | | (45)M | (45)M | (45)M |
| | R₄₅₀ | R₅₅₀ | R₆₅₀ | Rf₄₅₀ | Rf₅₅₀ | Rf₆₅₀ | Rs₄₅₀ | Rs₅₅₀ | Rs₆₅₀ | Rs₄₅₀ | Rs₅₅₀ | Rs₆₅₀ |
| | (0) | (0) | (0) | (45) | (45) | (45) | (45) | (45) | (45) | (45)M | (45)M | (45)M |
| Example 7 | 116.4 | 142.0 | 147.5 | 109.7 | 134.6 | 140.1 | 123.7 | 149.7 | 155.2 | 11.0 | 11.1 | 11.1 |
| Example 8 | 116.4 | 142.0 | 147.5 | 111.0 | 136.5 | 142.0 | 122.4 | 147.8 | 153.3 | 11.0 | 11.1 | 11.1 |
| Example 9 | 116.4 | 142.0 | 147.5 | 111.3 | 136.9 | 142.5 | 122.1 | 147.4 | 152.8 | 11.0 | 11.1 | 11.1 |

TABLE 6

| | Expres- | Expres- | Expres- | Expres- | Expres- | Expres- | Expres- | Expres- | Expres- | Evaluation result | |
|---|---|---|---|---|---|---|---|---|---|---|---|
| | sion (1) | sion (2) | sion (3) | sion (4) | sion (5) | sion (6) | sion (7) | sion (8) | sion (9) | Tint | Reflection |
| | α₄₅₀ | β₄₅₀ | \|α₄₅₀ + β₄₅₀\| | α₅₅₀ | β₅₅₀ | \|α₅₅₀ + β₅₅₀\| | α₆₅₀ | β₆₅₀ | \|α₆₅₀ + β₆₅₀\| | difference | intensity |
| Example 7 | 1.2 | 1.8 | 3.0 | 1.8 | 2.1 | 3.9 | 1.8 | 2.2 | 4.0 | B | A |
| Example 8 | 0.1 | 0.5 | 0.6 | 0.1 | 0.2 | 0.3 | 0.1 | 0.3 | 0.4 | A | A |
| Example 9 | 0.4 | 0.2 | 0.6 | 0.5 | 0.2 | 0.7 | 0.6 | 0.3 | 0.9 | A | A |

As shown in Table 6, it was found that the predetermined effect was obtained in Examples 7 to 9. In these examples, the aluminum foil was used, but even in a case where an image display element having reflectivity similar to that of the aluminum foil was used, the same effect as described above could be obtained.

### Explanation of References

10: image display device
20: polarizer
30: retardation layer
40: image display element
AA: absorption axis of polarizer
SA: in-plane slow axis of retardation layer
FA: in-plane fast axis of retardation layer
50: first direction
51: second direction
60: second plane or fourth plane

What is claimed is:

1. An image display device comprising, in the following order:
a polarizer;
a retardation layer; and
an image display element,
wherein an angle formed by an absorption axis of the polarizer and an in-plane slow axis of the retardation layer is 45°+5°, and
the image display device satisfies relationships of expressions (1) to (9),
$${α}_{450} = {R}_{450} ( 0 ) - \{ R {f}_{450} ( 45 ) + ( R {f}_{450} ( 45 ) M / 2 ) \} , \qquad the expression ( 1 )$$
$${β}_{450} = {R}_{450} ( 0 ) - \{ R {s}_{450} ( 45 ) - ( R {s}_{450} ( 45 ) M / 2 ) \} , \qquad the expression ( 2 )$$
$$\vert {α}_{450} \vert + \vert {β}_{450} \vert \leq 4. nm , \qquad the e xpression ( 3 )$$
$${α}_{550} = {R}_{550} ( 0 ) - \{ R {f}_{550} ( 45 ) + ( R {f}_{550} ( 45 ) M / 2 ) \} , \qquad the expression ( 4 )$$
$${β}_{550} = {R}_{550} ( 0 ) - \{ R {s}_{550} ( 45 ) - ( R {s}_{550} ( 45 ) M / 2 ) \} , \qquad the expression ( 5 )$$
$$\vert {α}_{550} \vert + \vert {β}_{550} \vert \leq 4.1 nm , \qquad the expression ( 6 )$$
$${α}_{650} = {R}_{650} ( 0 ) - \{ R {f}_{650} ( 45 ) + ( R {f}_{650} ( 45 ) M / 2 ) \} , \qquad the expression ( 7 )$$
$${β}_{650} = {R}_{650} ( 0 ) - \{ R {s}_{650} ( 45 ) - ( R {s}_{650} ( 45 ) M / 2 ) \} , and \qquad the expression ( 8 )$$
$$\vert {α}_{650} \vert + \vert {β}_{650} \vert \leq 4. nm , \qquad the expression ( 9 )$$
R₄₅₀(0) represents an in-plane retardation of the retardation layer at a wavelength of 450 nm,
Rf₄₅₀(45) represents a phase difference of the retardation layer at a wavelength of 450 nm, which is measured from a first direction that is a direction tilted by a polar angle of 45° with respect to a normal direction to a surface of the retardation layer with an in-plane fast axis of the retardation layer as a rotation axis,
Rf₄₅₀(45)M represents a phase difference at a wavelength of 450 nm, which is calculated from a change in polarization state between measurement light and reflected light reflected by the image display element, in a case where the measurement light is incident on the image display element from the first direction and the reflected light is received, provided that, when the phase difference at the wavelength of 450 nm is measured, in a case where a plane including the first direction and a normal direction to a surface of the image display element is defined as a first plane, a direction tilted by a polar angle of 45° with respect to the normal direction to the surface of the image display element at an azimuthal angle deviated by 180° from an azimuthal angle of the first direction is defined as a second direction, and a plane having the second direction as a normal direction is defined as a second plane, as a slow axis is indicated in a direction parallel to the first plane in the second plane, a value of the phase difference represented by Rf₄₅₀(45)M is represented by a positive value, and as a slow axis is indicated in a direction orthogonal to the first plane in the second plane, a value of the phase difference represented by Rf₄₅₀(45)M is represented by a negative value,
Rs₄₅₀ (45) represents a phase difference of the retardation layer at a wavelength of 450 nm, which is measured from a third direction that is a direction tilted by a polar angle of 45° with respect to the normal direction to the surface of the retardation layer with an in-plane slow axis of the retardation layer as a rotation axis,
Rs₄₅₀(45)M represents a phase difference at a wavelength of 450 nm, which is calculated from a change in polarization state between measurement light and reflected light reflected by the image display element, in a case where the measurement light is incident on the image display element from the third direction and the reflected light is received, provided that, when the phase difference at the wavelength of 450 nm is measured, in a case where a plane including the third direction and a normal direction to a surface of the image display element is defined as a third plane, a direction tilted by a polar angle of 45° with respect to the normal direction to the surface of the image display element at an azimuthal angle deviated by 180° from an azimuthal angle of the third direction is defined as a fourth direction, and a plane having the fourth direction as a normal direction is defined as a fourth plane, as a slow axis is indicated in a direction parallel to the third plane in the fourth plane, a value of the phase difference represented by Rs₄₅₀(45)M is represented by a positive value, and as a slow axis is indicated in a direction orthogonal to the third plane in the fourth plane, a value of the phase difference represented by Rs₄₅₀(45)M is represented by a negative value,
R₅₅₀(0) represents an in-plane retardation of the retardation layer at a wavelength of 550 nm,
Rf₅₅₀(45) represents a phase difference of the retardation layer at a wavelength of 550 nm, which is measured from the first direction,
Rs₅₅₀(45) represents a phase difference of the retardation layer at a wavelength of 550 nm, which is measured from the third direction,
Rf₅₅₀(45)M represents a phase difference at a wavelength of 550 nm, which is calculated from a change in polarization state between measurement light and reflected light reflected by the image display element, in a case where the measurement light is incident on the image display element from the first direction and the reflected light is received, provided that, when the phase difference at a wavelength of 550 nm is measured, as a slow axis is indicated in a direction parallel to the first plane in the second plane, a value of the phase difference represented by Rf₅₅₀(45)M is represented by a positive value, and as a slow axis is indicated in a direction orthogonal to the first plane in the second plane, a value of the phase difference represented by Rf₅₅₀(45)M is represented by a negative value,
Rs₅₅₀(45)M represents a phase difference at a wavelength of 550 nm, which is calculated from a change in polarization state between measurement light and reflected light reflected by the image display element, in a case where the measurement light is incident on the image display element from the third direction and the reflected light is received, provided that, when the phase difference at a wavelength of 550 nm is measured, as a slow axis is indicated in a direction parallel to the third plane in the fourth plane, a value of the phase difference represented by Rs₅₅₀(45)M is represented by a positive value, and as a slow axis is indicated in a direction orthogonal to the third plane in the fourth plane, a value of the phase difference represented by Rs₅₅₀(45)M is represented by a negative value,
R₆₅₀(0) represents an in-plane retardation of the retardation layer at a wavelength of 650 nm,
Rf₆₅₀(45) represents a phase difference of the retardation layer at a wavelength of 650 nm, which is measured from the first direction,
Rs₆₅₀(45) represents a phase difference of the retardation layer at a wavelength of 650 nm, which is measured from the third direction,
Rf₆₅₀(45)M represents a phase difference at a wavelength of 650 nm, which is calculated from a change in polarization state between measurement light and reflected light reflected by the image display element, in a case where the measurement light is incident on the image display element from the first direction and the reflected light is received, provided that, when the phase difference at a wavelength of 650 nm is measured, as a slow axis is indicated in a direction parallel to the first plane in the second plane, a value of the phase difference represented by Rf₆₅₀(45)M is represented by a positive value, and as a slow axis is indicated in a direction orthogonal to the first plane in the second plane, a value of the phase difference represented by Rf₆₅₀(45)M is represented by a negative value, and
Rs₆₅₀(45)M represents a phase difference at a wavelength of 650 nm, which is calculated from a change in polarization state between measurement light and reflected light reflected by the image display element, in a case where the measurement light is incident on the image display element from the third direction and the reflected light is received, provided that, when the phase difference at a wavelength of 650 nm is measured, as a slow axis is indicated in a direction parallel to the third plane in the fourth plane, a value of the phase difference represented by Rs₆₅₀(45)M is represented by a positive value, and as a slow axis is indicated in a direction orthogonal to the third plane in the fourth plane, a value of the phase difference represented by Rs₆₅₀(45)M is represented by a negative value.

2. The image display device according to claim 1,
wherein both Rf₄₅₀(45)M and Rs₄₅₀(45)M are −25 to −5 nm,
both Rf₅₅₀(45)M and Rs₅₅₀(45)M are −15 to 5 nm, and
both Rf₆₅₀(45)M and Rs₆₅₀(45)M are −10 to 10 nm.

3. The image display device according to claim 1,
wherein the image display device further satisfies a relationship of an expression (3-1), a relationship of an expression (6-1), and a relationship of an expression (9-1),
$$0 nm \leq \vert {α}_{450} \vert + \vert {β}_{450} \vert \leq 3.5 nm , \qquad the expression ( 3 - 1 )$$
$$0 nm \leq \vert {α}_{550} \vert + \vert {β}_{550} \vert \leq 3.5 nm , and \qquad the expression ( 6 - 1 )$$
$$0 nm \leq \vert {α}_{650} \vert + \vert {β}_{650} \vert \leq 3.5 nm . \qquad the expression ( 9 - 1 )$$

4. The image display device according to claim 1,
wherein the retardation layer includes an A-plate and a C-plate.
